(19) United States
(12) Patent Application Publication
(10) Pub. No.: US 2026/0287705 A1
(43) Pub. Date: Sep. 24, 2026

(54) POSITION ACCURACY ESTIMATION FOR GEOLOCATION SYSTEMS

(71) Applicant: PHY Wireless, LLC, San Diego, CA (US)

(72) Inventors: Zeinab Shadram, San Diego, CA (US); Steven C. Thompson, Solana Beach, CA (US)

(73) Assignee: PHY Wireless, LLC, San Diego, CA (US)

(21) Appl. No.: 19/466,264

(22) Filed: Jan. 30, 2026

Related U.S. Application Data
(60) Provisional application No. 63/751,569, filed on Jan. 30, 2025.

(51) Int. Cl. G01S 5/02

(52) U.S. Cl. CPC G01S 5/0244; G01S 5/0242; G01S 5/0284; G01S 5/0295

(57) ABSTRACT

A method for estimating positioning accuracy for a UE includes determining location information for base stations associated with a wireless communication network, performing a first positioning operation by receiving a first PRS from each of the base stations, determining first RSTD measurements based on the first PRS, estimating a first position of the UE based on the first RSTD measurements and the location information; and estimating an accuracy of the first position estimate based at least in part on the first position estimate and an actual location of the UE, and also include performing a second positioning operation based at least in part on the accuracy estimate determined for the first positioning operation.

### CROSS REFERENCE TO RELATED APPLICATIONS

This patent application claims priority to U.S. Provisional Patent Application No. 63/751,569 entitled “POSITION ACCURACY ESTIMATION FOR GEOLOCATION SYSTEMS” and filed on Jan. 30, 2025, which is assigned to the assignee hereof. The disclosures of all prior applications are considered part of and are incorporated by reference in this patent application.

### TECHNICAL FIELD

This disclosure relates generally to mobile wireless devices, and, more particularly, to determining positions of mobile wireless devices.

### DESCRIPTION OF RELATED ART

Geolocation has found widespread application in recent decades, and its use continues to grow. Billions of people use global navigation satellite systems (GNSS) on their smartphones for navigation. Wi-Fi access point databases help locate devices indoors where GNSS is unavailable. Bluetooth beacons are used for indoor location applications. Ultra-wideband systems have been integrated into products such as AirTags available from Apple Inc. Cellular-based location systems are also growing in popularity. Cellular communication systems such as Long-Term Evolution (LTE) and the fifth-generation new radio (5G NR) defined by the 3GPP standards provide global wireless communication coverage that can provide both indoor and outdoor coverage.

Although designed to provide voice and data services to users, cellular communication systems can also be used for positioning operations. For example, the position of user equipment (UE) associated with base stations having known locations can be determined using the cell identification (CID) of the UE's serving cell. Enhanced CID (E-CID) positioning techniques can use angle of arrival (AOA) information and time of flight (ToF) measurements of positioning reference signals (PRS) transmitted to the UE to determine the UE's location relative to its serving cell. Timing offsets between the serving cell and the UE may cause inaccuracies in these ToF measurements, which in turn may reduce the accuracy of position estimates based on AoA and ToF measurements. Although time-difference-of-arrival (TDOA) positioning techniques may be used to reduce timing offsets by determining the UE's position based on the difference in arrival times of different PRS signals received at the UE from different base stations, channel impairment, interference, atmospheric conditions, and other conditions can also cause inaccuracies in ToF measurements. As such, it is desirable to increase the estimate of accuracy associated with positioning operations in a wireless communication network.

### SUMMARY

This summary is provided to introduce in a simplified form a selection of concepts that are further described below in the Detailed Description section. This Summary is not intended to identify key features or essential features of the claimed subject matter, nor is it intended to limit the scope of the claimed subject matter.

A method for estimating positioning accuracy for a user equipment (UE) is disclosed. The method may be performed by the UE, and may include determining location information for a group of base stations associated with a wireless communication network and performing a first positioning operation by receiving, over the wireless communication network, a first positioning reference signal (PRS) from each of the base stations, determining first reference signal time difference (RSTD) measurements based on the first PRS, estimating a first position of the UE based on the first RSTD measurements and the location information, and estimating an accuracy of the first position estimate based at least in part on the first position estimate and an actual location of the UE. The method may also include performing a second positioning operation based at least in part on the accuracy estimate determined for the first positioning operation. In some instances, determining the location information includes retrieving, from a memory associated with the UE, location data for the plurality of selected base stations. In some aspects, the location data stored in the UE is a subset of a base station almanac (BSA) associated with the wireless communication network.

In some implementations, performing the second positioning operation includes receiving, over the wireless communication network, a second PRS from each of the base stations, determining second RSTD measurements based on the second PRS and the accuracy estimate of the first position estimate, and estimating a second position of the UE based on the second RSTD measurements, the location information, and the accuracy estimate of the first position estimate. The second positioning operation may also include estimating an accuracy of the second position estimate based at least in part on the second position estimate and the actual location of the UE. In some aspects, estimating the second position includes dynamically adjusting one or both of the second RSTD measurements and the second estimated position based on the accuracy estimate for the first positioning operation.

In some implementations, the accuracy estimate is generated by a decision tree classifier based at least in part on a feature vector generated by the UE during the first positioning operation. The feature vector may include a number of base stations participating in the first positioning operation, a time-difference of arrival (TDOA) residual error, an estimated geometric dilution of precision (GDOP) of the accuracy estimate, and a normalized distance and angle product (NDAP) of the first position estimate generated by the UE during the first positioning operation. In some instances, the accuracy estimate generated by the decision tree classifier is further based on one or more operating parameters of at least one of the base stations. The one or more operating parameters includes a nominal ranging distance of the at least one base station, a maximum antenna range (MAR) of the at least one base station, a received signal strength indicators (RSSI) of the at least one base station, and an effective isotropically radiated power (EIRP) of the at least one base station.

The decision tree classifier may be trained by a management server associated with the wireless communication network using datasets generated by the UE during a plurality of previous positioning operations. In some aspects, the trained decision tree classifier may be obtained by the UE from the management server as an over-the-air firmware update.

In some implementations, the method may also include capturing in-phase (I) and quadrature (Q) components of PRS received during a plurality of previous positioning operations, determining a device state vector indicating one or more of a received signal strength indicator (RSSI), a reference signal received power (RSRP), a reference signal received quality (RSRQ), PRS timestamps, angle of departure (AoD) information, angle of arrival (AoA) information, or band information for each of the plurality of previous positioning operations, generating a capture log by concatenating the captured I/Q components and the device state vector, and forming the datasets based on a combination of the capture log and the feature vector. In some aspects, the method may also include training the decision tree classifier using the datasets.

A user equipment (UE) is also disclosed. The UE may include a transceiver, a processor coupled to the transceiver, and a memory storing instructions. In some implementations, execution of the instructions by the processor causes the wireless communication device to determine location information for a group of base stations associated with a wireless communication network and perform a first positioning operation by receiving, over the wireless communication network, a first positioning reference signal (PRS) from each of the base stations, determining first reference signal time difference (RSTD) measurements based on the first PRS, estimating a first position of the UE based on the first RSTD measurements and the location information, and estimating an accuracy of the first position estimate based at least in part on the first position estimate and an actual location of the UE. Execution of the instructions may also cause the UE to perform a second positioning operation based at least in part on the accuracy estimate determined for the first positioning operation. In some instances, determining the location information includes retrieving, from a memory associated with the UE, location data for the plurality of selected base stations. In some aspects, the location data stored in the UE is a subset of a base station almanac (BSA) associated with the wireless communication network.

In some implementations, execution of the instructions to perform the second positioning operation causes the UE to receive, over the wireless communication network, a second PRS from each of the base stations, to determine second RSTD measurements based on the second PRS and the accuracy estimate of the first position estimate, and to estimate a second position of the UE based on the second RSTD measurements, the location information, and the accuracy estimate of the first position estimate. Execution of the instructions to perform the second positioning operation may also cause the UE to estimate an accuracy of the second position estimate based at least in part on the second position estimate and the actual location of the UE. In some aspects, execution of the instructions to estimate the second position causes the UE to dynamically adjust one or both of the second RSTD measurements and the second estimated position based on the accuracy estimate for the first positioning operation.

In some implementations, the UE may include a decision tree classifier configured to generate the accuracy estimate based at least in part on a feature vector generated by the UE during the first positioning operation. The feature vector may include a number of base stations participating in the first positioning operation, a time-difference of arrival (TDOA) residual error, an estimated geometric dilution of precision (GDOP) of the accuracy estimate, and a normalized distance and angle product (NDAP) of the first position estimate generated by the UE during the first positioning operation. In some instances, the accuracy estimate generated by the decision tree classifier is further based on one or more operating parameters of at least one of the base stations. The one or more operating parameters includes a nominal ranging distance of the at least one base station, a maximum antenna range (MAR) of the at least one base station, a received signal strength indicators (RSSI) of the at least one base station, and an effective isotropically radiated power (EIRP) of the at least one base station.

The decision tree classifier may be trained by a management server associated with the wireless communication network using datasets generated by the UE during a plurality of previous positioning operations. In some aspects, the trained decision tree classifier may be obtained by the UE from the management server as an over-the-air firmware update.

In some implementations, execution of the instructions further causes the UE to capture in-phase (I) and quadrature (Q) components of PRS received during a plurality of previous positioning operations, to determine a device state vector indicating one or more of a received signal strength indicator (RSSI), a reference signal received power (RSRP), a reference signal received quality (RSRQ), PRS timestamps, angle of departure (AoD) information, angle of arrival (AoA) information, or band information for each of the plurality of previous positioning operations, to generate a capture log by concatenating the captured I/Q components and the device state vector, and to form the datasets based on a combination of the capture log and the feature vector. In some aspects, execution of the instructions further causes the UE to train the decision tree classifier using the datasets.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example wireless communications system, according to some implementations.

FIG. 2A shows a first 5G/NR frame.

FIG. 2B shows example downlink (DL) channels within a slot of the first 5G/NR frame.

FIG. 2C shows an example of a second 5G/NR frame.

FIG. 2D shows example DL channels within a slot of the second 5G/NR frame.

FIG. 3 shows a diagram illustrating an example base station and user equipment (UE) in an access network.

FIG. 4 shows a timing diagram of a conventional UE-assisted positioning operation.

FIG. 5 shows a timing diagram of a UE-based positioning operation using an accuracy estimator, in accordance with some implementations.

FIG. 6 shows a timing diagram of another UE-based positioning operation 600 in which the UE also determines a capture log, in accordance with some implementations.

FIG. 7 shows a block diagram of a machine learning (ML) model configured to determine an accuracy estimate, in accordance with some implementations.

FIG. 8 shows a block diagram of a system configured to generate one or more datasets, in accordance with some implementations.

FIG. 9 shows an example decision tree classifier (DTC), in accordance with some implementations.

FIG. 10 shows a system for generating classification mappings for a ML model, in accordance with some implementations.

FIG. 11 shows a coverage area of an example serving cell, in accordance with some implementations.

FIG. 12 shows a graph depicting example relationships between the normalized angle and the normalized distance for network data captured in the United States, in accordance with some implementations.

FIG. 13 shows an example radiation pattern from a serving cell in a 5G/NR cellular network.

FIG. 14 shows a graph depicting normalized distance and angle product (NDAP) information associated with the network data described with respect to FIG. 11, in accordance with some implementations.

FIG. 15 shows an example plot depicting an estimated UE location in relation to its true location, in accordance with some implementations.

FIG. 16 shows a graph depicting the class probability mass function (PMF) and the class cumulative distribution function (CDF) as a function of class ID, in accordance with some implementations.

FIG. 17 shows a graph depicting first performance metrics of a positioning operation as a function of the number of leaves of a mode-based decision tree classifier (DTC-M) used in the positioning operation, in accordance with some implementations.

FIG. 18 shows a graph depicting second performance metrics of a positioning operation as a function of the number of leaves of the DTC-M used in the positioning operation, in accordance with some implementations.

FIG. 19 shows example DTC-M matrices, in accordance with some implementations.

FIG. 20 shows a graph depicting the label RMSE values of a DTC-M as a function of the number of leaves of the DTC-M, in accordance with some implementations.

FIG. 21 shows a graph depicting the relative performances of the DTC-M and an expectation-type decision tree classifier (DTC-E) used for positioning operations, in accordance with some implementations.

FIG. 22 shows an example flow chart for estimating the position of a wireless communication device, in accordance with some implementations.

Like reference numbers and designations in the various drawings indicate like elements.

### DETAILED DESCRIPTION

The following description is directed to some example implementations for the purpose of describing the innovative aspects of this disclosure. However, a person that has ordinary skill in the art will readily recognize that the teachings herein can be applied in a multitude of different ways. The implementations described can be implemented in batteries for a variety of applications and may be tailored to compensate for various performance related deficiencies. As such, the disclosed implementations are not to be limited by the examples provided herein, but rather encompass all implementations contemplated by the attached claims. Additionally, well-known elements of the disclosure will not be described in detail or will be omitted so as not to obscure the relevant details of the disclosure.

Various aspects of the novel compositions and methods are described more fully herein with reference to the accompanying drawings. These aspects are provided so that this disclosure will be thorough and complete, and will fully convey the scope of the disclosure to those skilled in the art. Although some examples and aspects are described herein, many variations and permutations of these examples fall within the scope of the disclosure. Although some benefits and advantages of the various aspects are mentioned, the scope of the disclosure is not intended to be limited to benefits, uses, or objectives. The detailed description and drawings are merely illustrative of the disclosure rather than limiting, the scope of the disclosure being defined by the appended claims and equivalents thereof.

In some implementations, a decision tree classifier (DTC) may be used to estimate the accuracy of position estimates determined by the UE based on positioning reference signals (PRS) transmitted from a serving cell and one or more neighbor cells during a sequence of PRS occasions. The DTC may receive, as input, features determined by the UE during positioning operations as well as various operating parameters of the serving cell. The features determined by the UE may include the number of cells (e.g., base stations) that participate in the positioning operation, the TDOA residual error, the estimated geometric dilution of precision (GDOP), and the normalized distance and angle product (NDAP) (among other examples). The operating parameters may include the serving cell's nominal ranging distance, maximum antenna range (MAR), received signal strength indicators (RSSI), the effective isotropically radiated power (EIRP), estimation covariance matrices, and the number of iterations in an Iterative Gaussian Maximum Likelihood Taylor series Expansion (I-GML-TE) used to estimate position, among other examples.

The complexity of the DTC is proportional to the number of features, the number of classes, the tree depth, and the number of leaves. The configuration of the DTC is based on datasets spanning various environments (urban, indoor, outdoor), a diverse set of features, and an indication of a maximum level of complexity. In some instances, the DTC may be configured as a binary search tree, which minimizes power consumption and memory requirements of the UE (e.g., due to the relatively simple processing operations) compared to more complex, power hungry, and memory intensive ML models (such as neural networks). In other words, once the trained DTC is implemented in the UE, the computations associated with using the DTC to improve position and accuracy estimates generated by the UE are simpler, and therefore consume less power and memory, than more complex ML models (such as neural networks).

In some implementations, the UE may generate additional datasets during subsequent positioning operations, thereby creating increasing large and diverse datasets with which the DTC residing within the UE can be continually trained. In this manner, the accuracy with which the UE generates position estimates may continually increase over time by continually learning relationships between environmental conditions, feature sets, serving cell operating characteristics. In some instances, the UE may receive retrained DTCs from an associated management server or through firmware over-the-air (FOTA) updates.

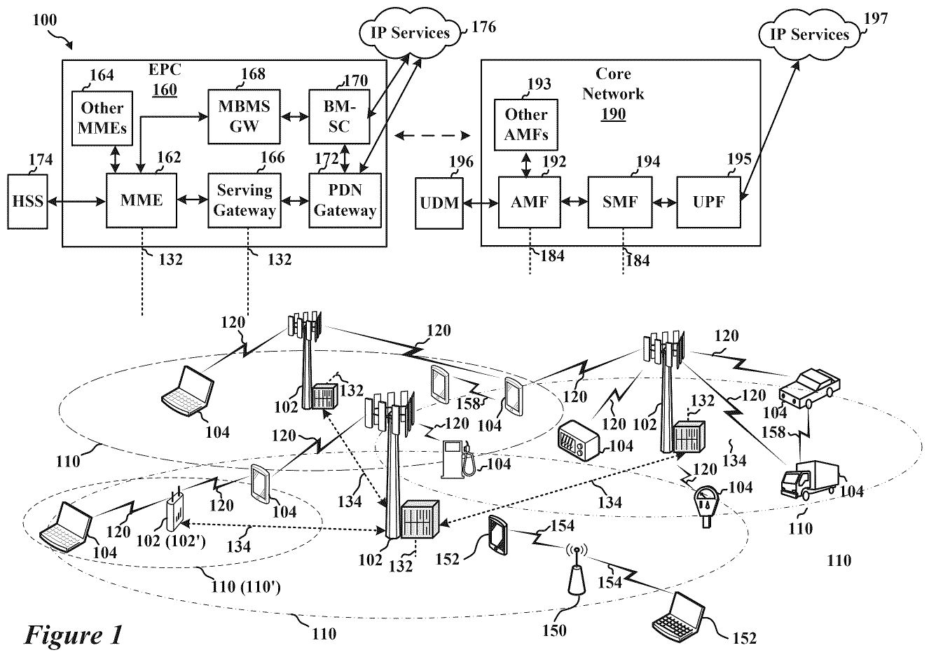

FIG. 1 shows a diagram of a wireless communications system 100. The wireless communications system 100 includes base stations 102, UEs 104, an Evolved Packet Core (EPC) 160, and another core network 190 (such as a SG Core (SGC)). The base stations 102 may include macrocells (high power cellular base station) or small cells (low power cellular base station). The macrocells include base stations. The small cells include femtocells, picocells, and microcells.

The base stations 102 configured for 4G L TE (collectively referred to as Evolved Universal Mobile Telecommunications System (UMTS) Terrestrial Radio Access Network (EUTRAN)) may interface with the EPC 160 through backhaul links 132 (such as the S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for nonaccess stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over backhaul links 134 (such as the X2 interface).

The backhaul links 134 may be wired or wireless. The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station. 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5 MHz, 10 MHz, 15 MHz, 20 MHz, 100 MHz, 400 MHz, etc.) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as a macro base station), may include an eNB, gNodeB (gNB), or another type of base station. Some base stations, such as gNB 180, may operate in a traditional sub 6 GHz spectrum, in millimeter wave (mmW) frequencies, or near mmW frequencies in communication with the UE 104. When the gNB 180 operates in mm W or near mm W frequencies, the gNB 180 may be referred to as a millimeter wave or mm W base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mm W radio frequency band (such as between 3 GHz-300 GHz) has extremely high path loss and a short range. The mm W base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180 and UE 104 may perform beam training to determine the best receive and transmit directions for each of the base station 180 and UE 104. The transmit and receive directions for the base station 180 may or may not be the same. The transmit and receive directions for the UE 104 may or may not be the same.

The EPC 160 may provide user authentication, access authorization, tracking, Internet Protocol (IP) connectivity, and other access, routing, or mobility functions. In some implementations, the EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 is a control plane entity that manages access and mobility and may be in communication with a Home Subscriber Server (HSS) 174. The MME 162 may manage non-access stratum (NAS) functions such as mobility, authentication, and bearer management for UEs 104 served by base stations 104 associated with the EPC 160 and may process the signaling between the UEs 104 and the EPC 160. All user IP packets are transferred through the Serving Gateway 166, which is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting MBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station also may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as an MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

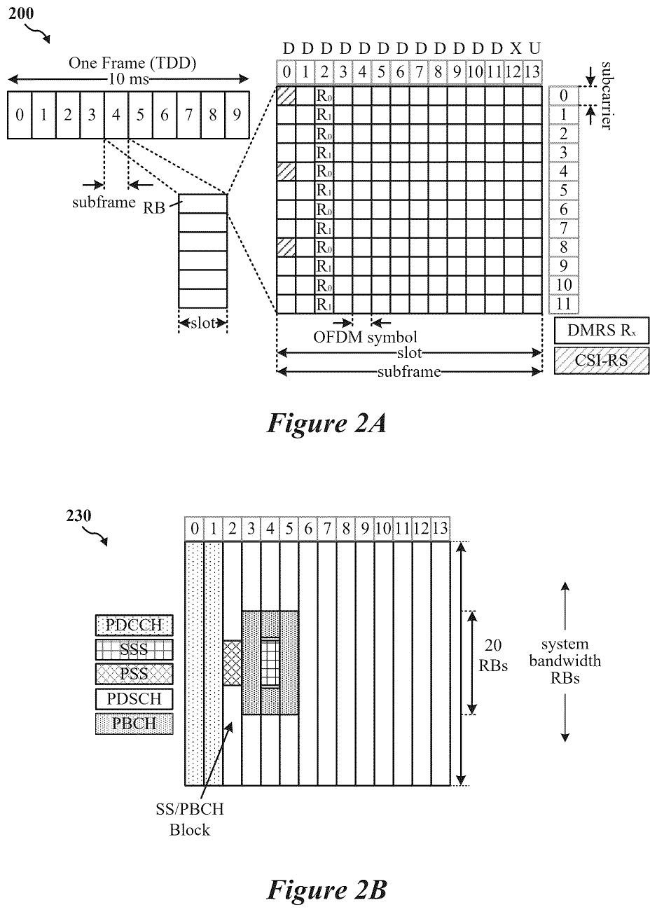

FIG. 2A shows an example of a first slot 200 within a 5G/NR frame structure, and FIG. 2B shows an example of DL channels 230 within a 5G/NR slot. FIG. 2C shows an example of a second slot 250 within a 5G/NR frame structure, and FIG. 2D shows an example of UL channels 280 within a 5G/NR slot. In some cases, the 5G/NR frame structure may be FDD in which, for a particular set of subcarriers (carrier system bandwidth), slots within the set of subcarriers are dedicated for either DL or UL transmissions. In other cases, the 5G/NR frame structure may be TDD in which, for a particular set of subcarriers (carrier system bandwidth), slots within the set of subcarriers are dedicated for both DL and UL transmissions. In the examples shown in FIGS. 2A and 2C, the SG/NR frame structure is based on TDD, with slot 4 configured with slot format 28 (with mostly DL), where D indicates DL, U indicates UL, and X indicates that the slot is flexible for use between DL and UL, and with slot 3 configured with slot format 34 (with mostly UL). While slots 3 and 4 are shown with slot formats 34 and 28, respectively, any particular slot may be configured with any of the various available slot formats 0-61. Slot formats 0 and 1 are all DL and all UL, respectively. Other slot formats 2-61 include a mix of DL, UL, and flexible symbols. UEs may be configured with the slot format, either dynamically through downlink control information (DCI) or semi-statically through radio resource control (RRC) signaling by a slot format indicator (SFI). The configured slot format also may apply to a 5G/NR frame structure that is based on FDD.

Other wireless communication technologies may have a different frame structure or different channels. A frame may be divided into a number of equally sized subframes. For example, a frame having a duration of 10 microseconds (μs) may be divided into 10 equally sized subframes each having a duration of 1 μs. Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (such as for high throughput scenarios) or discrete Fourier transform (DFT) spread OFDM (DFT-s-OFDM) symbols (also referred to as single carrier frequency division multiple access (SC-FDMA) symbols) (such as for power limited scenarios).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols per slot and 2μ slots per subframe. The subcarrier spacing and symbol length/duration are a function of the numerology. The subcarrier spacing may be equal to 2\hat{ }μ*15 kHz, where μ is the numerology 0 to 5. As such, the numerology μ=0 has a subcarrier spacing of 15 kHz, and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 microseconds (μs).

A resource grid may be used to represent the frame structure. Each time slot includes a resource block (RB) (also referred to as a physical RB (PRB)) that extends across 12 consecutive subcarriers and across a number of symbols. The intersections of subcarriers and across 14 symbols. The intersections of subcarriers and of the RB define multiple resource elements (REs). The number of bits carried by each RE depends on the modulation scheme.

As illustrated in FIG. 2A, some of the REs carry a reference signal (RS) for the UE. In some configurations, one or more REs may carry a demodulation reference signal (DMRS) (indicated as Rx for one particular configuration, where 100× is the port number, but other DM-RS configurations are possible). In some configurations, one or more REs may carry a channel state information reference signal (CSI-RS) for channel measurement at the UE. The REs also may include a beam measurement reference signal (BRS), a beam refinement reference signal (BRRS), and a phase tracking reference signal (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe or symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data and may additionally be used to carry a buffer status report (BSR), a power headroom report (PHR), or UCL.

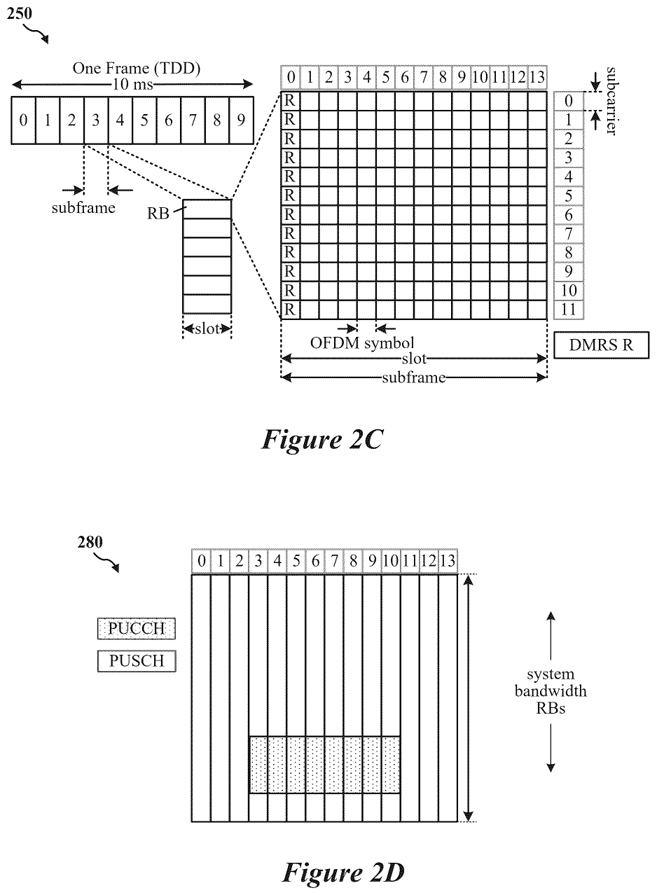

FIG. 3 shows a block diagram of an example base station 310 and UE 350 in an access network. In the DL, IP packets from the EPC 160 may be provided to a controller/processor 375 of the base station 310. The controller/processor 375 may implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 also may provide RRC layer functionality associated with broadcasting of system information (such as the MIB and SIBs), RRC connection control (such as RRC connection paging, RRC connection establishment, RRC connection modification, and RRC connection release), inter radio access technology (RAT) mobility, and measurement configuration for UE measurement reporting. The controller/processor 375 also may provide PDCP layer functionality associated with header compression/decompression, security (such as ciphering, deciphering, integrity protection, integrity verification), and handover support functions. The controller/processor 375 also may provide RLC layer functionality associated with the transfer of upper layer packet data units (PDUs), error correction through ARQ, concatenation, segmentation, and reassembly of RLC service data units (SDUs), re-segmentation of RLC data PD Us, and reordering of RLC data PD Us. The controller/processor 375 also may provide MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The processing system of the base station 310 may interface with other components of the base station 310, and may process information received from other components (such as inputs or signals), output information to other components, and the like. For example, a chip or modem of the base station 310 may include a processing system, a first interface to receive or obtain information, and a second interface to output, transmit or provide information. In some instances, the first interface may refer to an interface between the processing system of the chip or modem and a receiver, such that the base station 310 may receive information or signal inputs, and the information may be passed to the processing system. In some instances, the second interface may refer to an interface between the processing system of the chip or modem and a transmitter, such that the base station 310 may transmit information output from the chip or modem. A person having ordinary skill in the art will readily recognize that the second interface also may obtain or receive information or signal inputs, and the first interface also may output, transmit or provide information.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (MQAM)). The coded and modulated symbols may be split into parallel streams. Each stream may be mapped to an OFDM subcarrier, multiplexed with a reference signal (such as a pilot signal) in the time or frequency domain, and combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 of the UE 350 provides RRC layer functionality associated with system information (such as the MIB and SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PD Us, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations. Information to be wirelessly communicated (such as for LTE or NR based communications) is encoded and mapped, at the PHY layer, to one or more wireless channels for transmission.

As discussed above, positioning operations for mobile devices such as UEs is becoming increasingly important. UEs operating on cellular networks can use the LTE positioning protocol (LPP) defined by the 3GPP cellular standards. In LPP, positioning reference signal (PRS) subframes are embedded into designated orthogonal frequency division multiplexing (OFDM) symbols over specified time intervals, sometimes called positioning occasions or PRS occasions. The UE may measure the time of arrival (TOA) of PRS subframes from each accessible base station and determine at least one reference signal time difference (RSTD) between two different base stations (one called the reference and the other called the neighbor). The TOA and RSTD measurements may be made over a specified number of base stations and different corresponding combinations of RSTD measurements between ones of the set of base stations. The reference signal time difference is related to the established measure for observed time difference of arrival (OTDOA) described in the LTE positioning protocol.

In such cellular networks, an OFDM modulation scheme is used to transmit data bits over the air by applying quadrature amplitude modulation (QAM) to each active subcarrier that makes up an OFDM symbol. Each subcarrier may be assigned a function at the receiver, such as transmitting bits known a priori to the receiver and thus enabling different calculations. Thus, the reference signal time difference (RSTD) measurements are typically based on a predetermined number of subframe OFDM symbols.

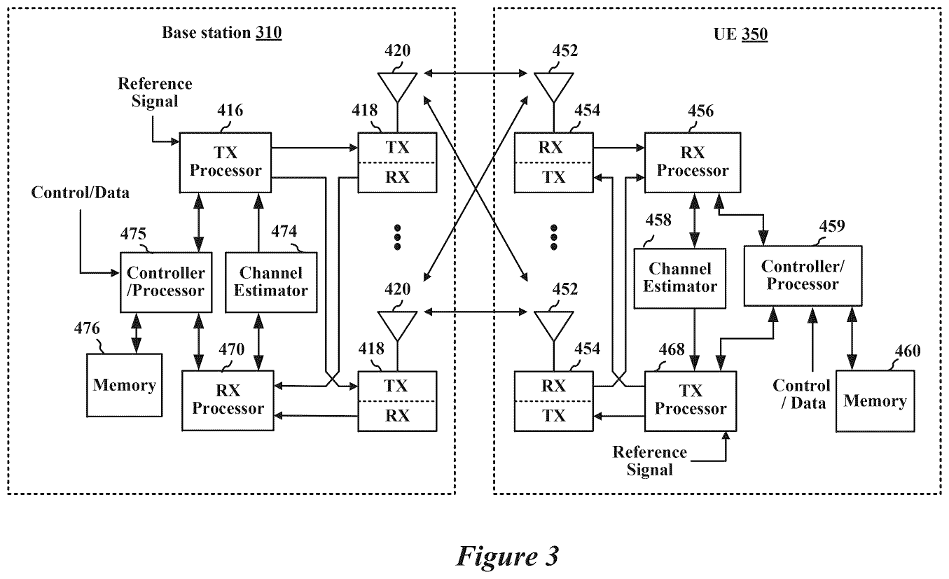

FIG. 4 shows a timing diagram of a conventional UE-assisted positioning operation 400 using PRS. At 402, the UE synchronizes with the network, identifying the serving cell based on signal strength, typically from PSS/SSS signals. At 404, the UE transmits its serving cell's ECGI (a unique identifier) to the location server. At 406, the location server provides assistance data to the UE. At 408, the UE uses PRS transmissions from a serving cell to generate measurement data. For example, in aspects for which the UE-assisted positioning operation 400 is based on TDOA or OTDOA positioning techniques, the measurement data may include timing information of the received PRS (e.g., timestamps of the received PRS or TDOA information associated with PRS received from multiple base stations, among other examples). For another example, in aspects for which the UE-assisted positioning operation 400 is based on AoA or AoD positioning techniques, the measurement data may include angle information of the received PRS (e.g., AoA information and/or AD information of the received PRS, among other examples). At 410, the UE sends the measurement data to the location server. At 412, the location server uses the measurement data to determine a location estimate for the UE. At 414, the location server sends the location estimate to the end-user application server.

The UE-assisted positioning operation 400 determines one position estimate based on the PRS received at an instance in time, and therefore may suffer from inaccuracies associated with a coincident interference, momentary degradations in channel conditions, and the like. Moreover, for the positioning operation 400, the UE sends the measurement data over the communications network to the location server at 410, and then the location server sends the determined position estimate over the communications network to the UE at 414. As such, the UE-assisted positioning operation 400 involves two frame exchanges of data to determine an estimate of the UE's location at a single instance in time, thereby consuming limited bandwidth of the communications network.

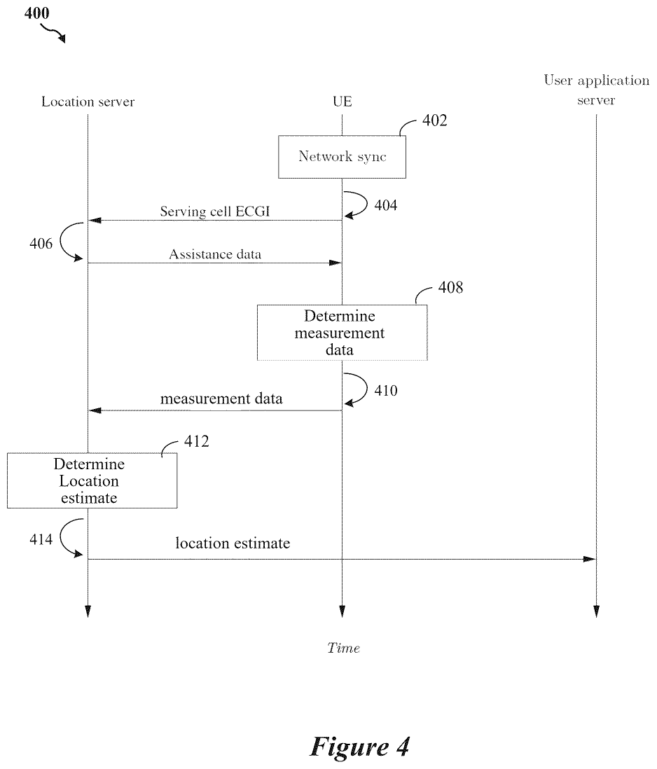

FIG. 5 shows a timing diagram of a UE-based positioning operation 500, in accordance with some implementations. In some instances, the positioning operation 500 may be performed by the UE 350 of FIG. 3. In other instances, the positioning operation 500 may be performed by another suitable wireless communication device. For the positioning operation 500, the UE stores a subset of the base station almanac (BSA) associated with the serving cell. The locally-stored subset of the BSA, referred to herein as a micro-BSA, contains identification, location, and configuration information of the serving cell and a plurality of neighbor base stations associated with a certain geographic region. The micro-BSA may be provided to the UE prior to the positioning operation 500. The UE can use information contained in the micro-BSA to determine the PRS occasions and precise locations of the serving cell and neighbor base stations, thereby eliminating the need for the UE to obtain assistance data. In this manner, the UE reduces power consumption, and therefore increases battery life, by not having to transmit a request for assistance data or to receive assistance data.

In some instances, the positioning operation 500 beings at time t1 with the UE synchronizing with the serving cell. At time t2, the determines whether the locally-stored micro-BSA contains location information of the serving cell and a number of neighbor base stations from which the UE is to receive PRS for the positioning operation 500. If so, the UE initializes an index k=0, and prepares to receive PRS transmissions. Otherwise, the UE sends the serving cell's ECGI to the location server at time t3, and the location server sends micro-BSA updates to the UE at time t4. The UE updates its micro-BSA with the updates provided by the location server, initializes the index k=0, and prepares to receive PRS transmissions.

At time t5, which corresponds to a first PRS instance, the UE increments the index (e.g., k=1) and receives a first set of PRS transmissions from the serving cell and a plurality of selected base stations. The UE determines first RSTD measurements based on the first set of PRS transmissions, and then determines a first position estimate based on the first RSTD measurements and the location information. In some instances, the UE stores the first RSTD measurements in a measurement vector r(k) at k=1, and stores the first position estimate in a position vector x(k) at k=1. The UE estimates the accuracy of the first position estimate, and stores the first accuracy estimate in an accuracy vector \tilde{η}(k) at k=1.

At time t6, which corresponds to a second PRS instance, the UE increments the index (e.g., k=2) and receives a second set of PRS transmissions from the serving cell and a plurality of selected base stations. The UE determines second RSTD measurements based on the second set of PRS transmissions, and then determines a second position estimate based on the second RSTD measurements and the location information. The UE stores the second RSTD measurements in the measurement vector r(k) at k=2, and stores the second position estimate in the position vector x(k) at k=2. The UE estimates the accuracy of the second position estimate, and stores the second accuracy estimate in the accuracy vector \tilde{η}(k) at k=2. In accordance with aspects of the present disclosure, the UE may use the first accuracy estimate \tilde{η}(1) determined during the first PRS instance to selectively adjust one or both of the second RSTD measurements r(2) and the second position estimate x(2), thereby increasing the accuracy of one or both of the second RSTD measurements r(2) and the second position estimate x(2), respectively. In some aspects, the accuracy estimate may be used to adjust the measurement vector and the position estimate by adjusting the covariance matrix of a Kalman filter associated with the measurement vector and the position vector, respectively.

The positioning operation 500 continues for each incremented value of the measurement index until the k=K^{th} PRS instance begins at time t7 with the UE receiving the final set of PRS transmissions PRS_{K}. receives a second set of PRS transmissions from the serving cell and a plurality of selected base stations. The UE determines the final RSTD measurements based on the K^{th} set of PRS transmissions, and then determines a final position estimate based on the final RSTD measurements and the location information. The UE stores the final RSTD measurements in the measurement vector r(k) at k=K, and stores the final position estimate in the position vector x(k) at k=K. The UE estimates the accuracy of the final position estimate, and stores the final accuracy estimate in the accuracy vector \tilde{η}(k) at k=K. In accordance with aspects of the present disclosure, the UE may use the accumulated accuracy vector \tilde{η}(K−1) determined during the previous PRS instance to selectively adjust one or both of the final RSTD measurements r(K) and the final position estimate x(K), thereby increasing the accuracy of one or both of the final RSTD measurements and the final position estimate, respectively. At time t8, the UE may send the final position estimate and the final accuracy estimate to the location server.

For the example positioning operation 500, the measurement vector is updated with a new RSTD measurement during each PRS occasion, the position vector is updated with a new position estimate during each PRS occasion, and the accuracy vector is updated with a accuracy estimate during each PRS occasion. In other implementations, the position vector and the accuracy vector may be updated with new position and accuracy estimates, respectively, less frequently (e.g., every n^{th} PRS occasion, where 2≤n<K) to minimize power consumption associated with updating the respective vectors. In other instances, previous values for the measurement vector and the position estimate may be restored. In some other implementations, a series of position estimates may be stored and the UE may retrieve the stored position estimate with the highest accuracy. In addition, or in the alternative, the accuracy estimate may be used to dynamically adjust the calculation of assistance data, which in turn may increase the accuracy of position estimates based on assistance data.

In some implementations, the UE may perform the positioning operation 500 under various other operating conditions and/or environments to determine location information and accuracy estimates for diverse environments. For example, the UE may compare accuracy estimates for indoor locations with accuracy estimates for outdoor locations to determine accuracy error difference vectors, which in turn may be used to adjust the parameters employed when adjusting the RSTD measurements and position estimates for a given PRS occasion with the accuracy vector determined for the previous PRS occasion depending on whether the UE is located indoors or outdoors. For another example, the UE may compare accuracy estimates for urban environments with accuracy estimates for suburban or rural environments to determine accuracy error difference vectors, which in turn may be used to adjust the parameters employed when adjusting the RSTD measurements and position estimates for a given PRS occasion with the accuracy vector determined for the previous PRS occasion depending on whether the UE is located in urban environment, a suburban environment, or a rural environment.

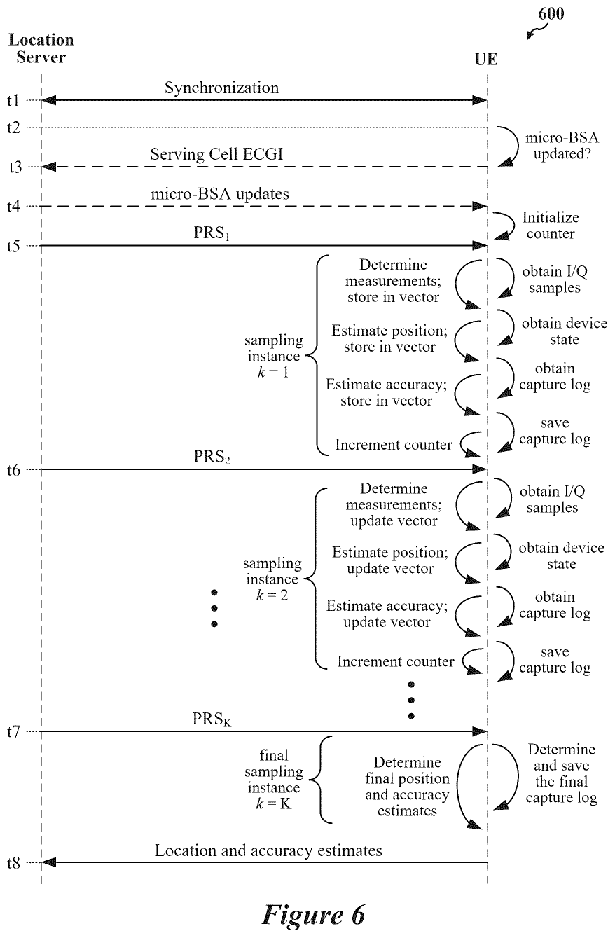

The accuracy vector may be stored in a database, which may reside in the UE, in a management server, or in the serving cell, and thereafter used as an input for training a ML model configured to determine position estimates and accuracy estimates by the UE, for example, as described below with respect to FIG. 7. In some aspects, the accuracy vector may be determined as a norm function (e.g., such as a Euclidean distance) between the position vector and the actual UE location for each value of the measurement index k:

$$η ( k ) = ‖ \hat{x} ( k ) - x ‖ .$$

A summary of the parameters that may be used in the positioning operation 500 is shown below in Table 1.

TABLE 1

| Parameter | Description |
|---|---|
| x | UE location |
| k | Time index, k = 1, 2. . . . , K |
| K | Final position estimate time |
| r(k) | Measurement vector at time k |
| \hat{x}(k) = x + n(k) | Position estimate at time k |
| n(k) | Position estimate error vector at time k |
| η(k) = \|\|n(k)\|\| | Position estimate accuracy at time k |
| \hat{η}(k) = η(k) + e(k) | Accuracy estimate at time k |
| e(k) | Accuracy estimate error at time k |

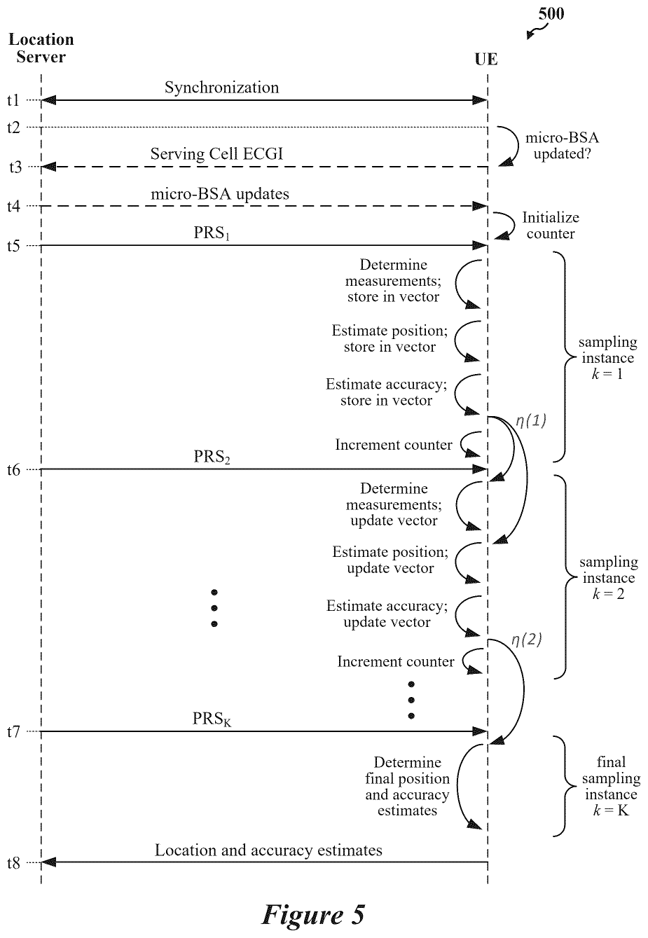

In some implementations, the UE may determine a capture log that can be used train the ML model configured to determine position estimates and accuracy estimates. For example, FIG. 6 shows a timing diagram of another UE-based positioning operation 600 in which the UE also determines a capture log, in accordance with some implementations. In some instances, the positioning operation 600 may be performed by the UE 350 of FIG. 3. In other instances, the positioning operation 600 may be performed by another suitable wireless communication device. The positioning operation 600 includes aspect of the positioning operation 500 of FIG. 5, and therefore the operations for determining the measurement vector, position vector, and accuracy vector are not repeated here.

During the first PRS occasion in FIG. 6, the UE captures in-phase (I) and quadrature (Q) components of the first PRS transmissions at time t5, and then determines device state information based at least in part on the captured I/Q samples. In some instances, the device state vector may include metric such as Received Signal Strength Indicator (RSSI), Reference Signal Received Power (RSRP), Reference Signal Received Quality (RSRQ), PRS timestamps, AoA and/or AoD information, system frame numbers, frequency hopping status, and band information, among other examples. The device state information may be stored in a device state vector d(k) at k=2. The UE determines a capture log entry for the first PRS occasion by concatenating the captured I/Q samples and the device state vector, and then stores the capture entry in a capture log c(k) at k=1.

During the second PRS occasion in FIG. 6, the UE captures I/Q components of the second PRS transmissions at time 16, and then determines device state information based at least in part on the captured I/Q samples. The device state information is stored in the device state vector d(k) at k=2. The UE determines a capture log entry for the second PRS occasion by concatenating the captured I/Q samples and the device state vector, and then stores the capture entry in the capture log c(k) at k=2.

During the final PRS occasion in FIG. 6, the UE captures I/Q components of the final PRS transmissions at time t7, and then determines device state information based at least in part on the captured I/Q samples. The device state information is stored in the device state vector d(k) at k=K. The UE determines a capture log entry for the final PRS occasion by concatenating the captured I/Q samples and the device state vector, and then stores the capture entry in the capture log c(k) at k=K.

Thereafter, the UE determines a feature vector f(k) that may include various attributes such as TOA variance and the estimated GDOP. The capture log and the feature vector may be stored in memory as a data point. A plurality of these data points is collected to form a corresponding dataset that may include, for example, thousands of data points. The collected data can be used to construct a machine learning (ML) model that can be configured to determine accuracy estimates for the UE.

For example, shows a machine learning (ML) model 700 configured to determine an accuracy estimate for the UE, in accordance with some implementations. The ML model 700, which may be implemented with a UE (such as the UE 350 of FIG. 3), is configured to generate an accuracy estimate based on a feature vector generated by the UE. In some aspects, the ML model 700 may be configured to generate an accuracy vector based on a plurality of accuracy estimates determined during a corresponding plurality of positioning operations 600, and to use the accuracy vector to iteratively adjust the RSTD measurements and/or the position estimates during a sequence or succession of the positioning operations 600.

In some implementations, the features may be generated by the UE during the positioning operation 600 of FIG. 6, and may include the number of cells (e.g., base stations) that participate in the positioning operation 600, the TDOA residual error, the estimated geometric dilution of precision (GDOP), and the normalized distance and angle product (NDAP), among other examples. In some instances, the UE can generate a set of features for each of a plurality of successive positioning operations 600 and then create a feature vector that includes the resulting plurality of feature sets, for example, in which each feature set corresponds to a unique time and may also correspond to a unique operating environment (e.g., indoors versus outdoors).

In some instances, the ML model 700 may be implemented as a single decision tree classifier (DTC) that can be trained using one or more datasets generated by the UE during a plurality of the positioning operations 600. By using a single DTC to estimate the accuracy of position estimates determined by the UE, aspects of the present disclosure may reduce power consumption and minimize memory resources compared to using a plurality of DTCs, and are therefore well-suited UEs (and other mobile communication devices) that have limited battery life and memory resources. In some aspects, implementations disclosed herein may determine a balance between the performance and complexity of the DTC that provides a certain level of positioning accuracy while consuming less than a threshold amount of memory resources. In other instances, the ML model 700 may be trained using supervision via using linear regressors, support vector machines, k-nearest neighbors, and neural networks, among other examples. In some other instances, the ML model 700 may be trained without supervision using k-means clustering or principal component analysis, among other examples.

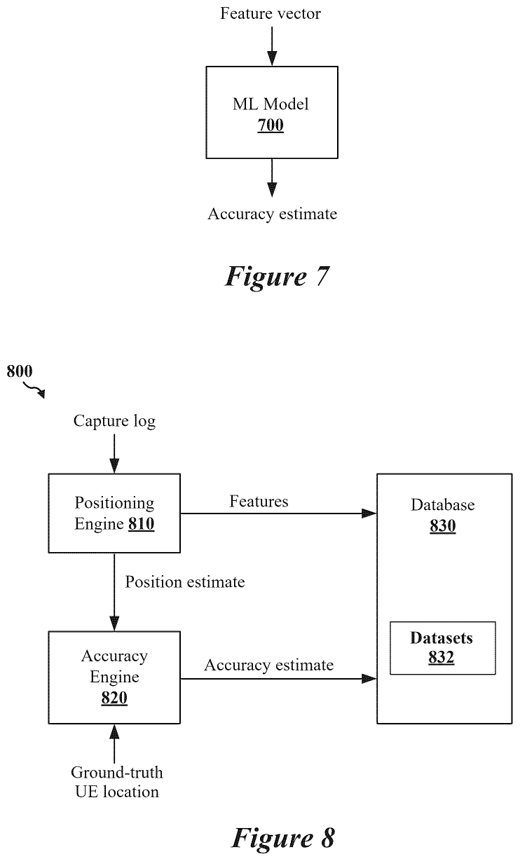

FIG. 8 shows a block diagram of a system 800 configured to generate one or more datasets, in accordance with some implementations. The datasets generated by the system 800 may be used to train the ML model 700 of FIG. 7. The system 800 is shown to include a positioning engine 810, an accuracy engine 820, and a database 830. The positioning engine 810, which includes an input to receive the capture log described above with respect to FIG. 6, may be configured to determine a position estimate for the UE based on data contained within the received capture log and measurement data obtained during a positioning operation (e.g., the RSTD measurements described above with respect to the positioning operations 500 and 600). The positioning engine 810 may also generate one or more sets of features based on data contained in the capture log. In some aspects, a plurality of feature sets may be provided to the database 830 as a feature vector, which as described above may include number of cells participating in the positioning operation, the TDOA residual error, the GDOP, and the NDAP, among other examples.

The accuracy engine 820, which may include a first input to receive the position estimate determined by the positioning engine 810 and a second input to receive the UE's actual location (denoted by the 3GPP standards, and herein, as the ground-truth UE location), may be configured to estimate the accuracy of each UE position estimate based on the differences (e.g., in distance) between the UE position estimate and the ground-truth UE location. In some aspects, a plurality of accuracy estimates may be provided to the database 830 as an accuracy vector.

The database 830, which may be any suitable database, stores one or more datasets 832 formed as a combination of the feature vector provided by the positioning engine 810 and the accuracy vector provided by the accuracy engine 820. In some implementations, the feature vector may be split into a training feature vector and a testing feature vector. The training feature vector may be used to train the ML model 700 of FIG. 7, and the testing feature vector may be used to test or classify the trained ML model 700 of FIG. 7. In some aspects, one or more hyperparameters (described above) may be used to limit the complexity (and thus an associated level of power consumption) of the ML model 700.

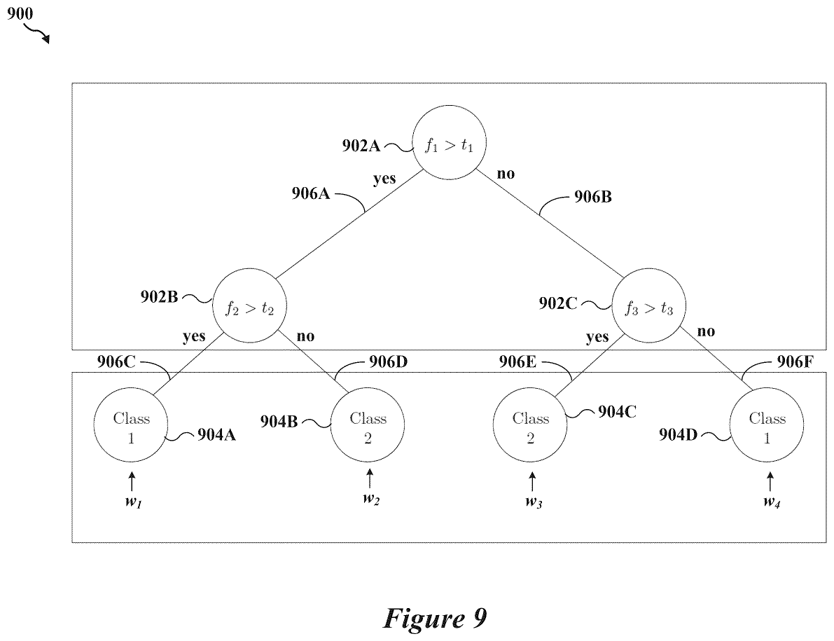

FIG. 9 shows an example DTC 900 including three decision nodes 902A-902C, four leaf nodes 904A-904D, and six branches 906A-906F. In some implementations, the DTC 900 may be used to implement aspects of the ML model 700 configured to determine position and accuracy estimates. The initial node 902A is connected to the other decision nodes 902B and 902C by branches 906A and 906B, respectively. The decision node 902B is connected to leaf nodes 904A and 904B by respective branches 906C and 906D, and the decision node 902C is connected to leaf nodes 904C and 904D by respective branches 906E and 906F. In the DTC 900, the decision nodes 902A-902C are associated with respective features f₁-f₃, leaves 904A-904D represent class labels, and the branches 906A-906F represent conjunctions of the features that lead to the class labels. Thus, the example DTC 900 has parameter values N_{feature}=3, and N_{leaf}=4, and N_{class}=2.

More specifically, each of the decision nodes 902A-902C is associated with a comparison between a feature value fᵢ and a corresponding threshold value tⱼ, leaves 904A and 904D are associated with Class 1 indicating a relatively accurate estimate, and leaves 904B and 904C are associated with Class 2 indicating a relatively inaccurate estimate. Thus, in the example of FIG. 9, decision node 902A determines whether the first feature f₁ is greater than a first threshold t₁. If f₁>t₁, then processing proceeds to decision node 902B which determines whether the second feature f₂ is greater than a second threshold t₂. If f₂>t₂, then processing proceeds to leaf node 904A and the estimate is classified as relatively accurate (e.g., class label=1). Conversely, if f₂≤t₂, then processing proceeds to leaf node 904B and the estimate is classified as relatively inaccurate (e.g., class label=2). Referring again to decision node 902A, if f₁≤t₁, then processing proceeds to decision node 902C which determines whether the third feature f₃ is greater than a third threshold t₃. If f₃>t₃, then processing proceeds to leaf node 904C and the estimate is classified as relatively inaccurate (e.g., class label=2). Conversely, if f₃≤t₃, then processing proceeds to leaf node 904D and the estimate is classified as relatively accurate (e.g., class label=1).

In general, the complexity of a DTC may be indicated by the amount of UE memory occupied by the DTC. For example, the amount of memory associated with implementing a DTC that allocates one byte (8-bits) for encoding of class IDs (thereby allowing for 2⁸=256 different classes and that allocates four bytes (32 bits) for each node in the DTC may be expressed as:

$$\begin{matrix}\frac{Bytes}{DTC nodes} = ( \frac{Bytes}{Leaf node} \times {N}_{leaf} ) + ( \frac{Bytes}{Decision node} \times {N}_{decision} ) \\ = {N}_{leaf} + 4 {N}_{decision} \\ = {N}_{leaf} + 4 ( {N}_{leaf} - 1 ) \\ < 5 {N}_{leaf}\end{matrix} .$$

Class labels may have a quantization of η that spans its expected range while minimizing the number of classes (such as less than a threshold number of classes), for example, to reduce the complexity (and thus the associated memory consumed) of the ML model. The 10-class mapping shown in Table 1 has an exponential scaling that spans a large range with a small number of DTC outputs. For a true accuracy (η), the class label (\tilde{η}) and class ID(H) are obtained from Table 2 below:

TABLE 2

| Class ID, H | Accuracy range (m) | Class label (m), \tilde{η} |
|---|---|---|
| 1 | 0 ≤ η < 40 | 40 |
| 2 | 40 ≤ η < 80 | 80 |
| 3 | 80 ≤ η < 160 | 160 |
| 4 | 160 ≤ η < 320 | 320 |
| 5 | 320 ≤ η < 640 | 640 |
| 6 | 640 ≤ η < 1280 | 1280 |
| 7 | 1280 ≤ η < 2560 | 2560 |
| 8 | 2560 ≤ η < 5120 | 5120 |
| 9 | 5120 ≤ η < 10240 | 10240 |
| 10 | 3 > 10240 | 20480 |

Thus, for the DTC 900, the leaves 904A and 904D corresponding to Class 1 may indicate an accuracy between 0 and 40 meters, and the leaves 904B and 904C corresponding to Class 2 may indicate an accuracy between 40 meters and 80 meters.

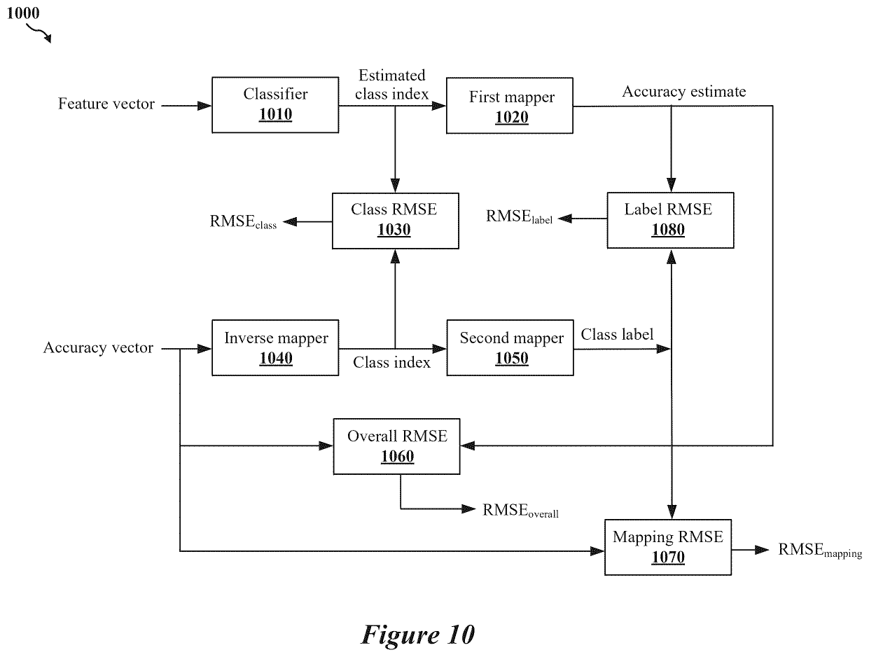

FIG. 10 shows a system 1000 for generating classification mappings for the ML model 700 of FIG. 7, in accordance with some implementations. The system 1000 includes a classifier 101, a first mapper 1020, a class RMSE circuit 1030, an inverse mapper 1040, a second mapper 1050, an overall RMSE 1060 circuit, a mapping RMSE circuit 1070, and a label RMSE 1080 circuit. Referring also to the system 800 of FIG. 8, the feature vector is retrieved from the database 830 and provided as an input to the classifier 1010, and a true accuracy vector is retrieved from the database 830 and provided as an input to the inverse mapper 1040, the overall RMSE 1060, and the mapping RMSE 1070. The classifier 1010 classifies the feature vector to generate an estimated class index, which is provided as input to the first mapper 1020 and the class RMSE 1030. The first mapper 1020 generates an accuracy estimate based on the estimated class index. The accuracy estimate is provided as an input to the label RMSE 1080 and the overall RMSE 1060.

The overall RMSE 1060 determines an overall RMSE value for accuracy (RMSEₒᵥₑᵣₐₗₗ) based on differences between accuracy estimates provided by the first mapper 1020 and corresponding true accuracies contained in the true accuracy vector retrieved from the database 830. The label RMSE 1080 determines a label RMSE value (RMSE_{label}) based on differences between accuracy estimates provided by the first mapper 1020 and the class labels generated by the second mapper 1050.

The mapping RMSE 1070 determines a mapping RMSE value (RMSE_{mapping}) based on differences between class labels provided by the first mapper 1020 and the true accuracy vector retrieved from the database 830. Together, the error metrics RMSEₒᵥₑᵣₐₗₗ, RMSE_{label}, RMSE_{class}, and RMSE_{mapping} may be stored as thereafter used to train the ML model 600 of FIG. 6.

Referring again to FIG. 9, after the DTC 900 is trained as described above, each the leaf nodes 904A-904D may be assigned a weight vector wₗ. The length (l) of the weight vector is equal to the number of classes N_{class}, and thus the weight vector length=2 and may store four different weights. For the example of FIG. 9, leaf node 904A is assigned a first weight w₁, leaf node 904B is assigned a second weight w₂, leaf node 904C is assigned a third weight w₃, and leaf node 904D is assigned a fourth weight w₄. The entry w_{l,i} denotes the number of samples Nₗ that reach the l^{th} leaf during training the DTC 900, and may be expressed as:

$${N}_{l} = {{\sum }_{i = 1}}^{{N}_{class}} {ω}_{l , i} ,$$

where l=1, 2, . . . , N_{leaf}. The estimated probability that the i^{th} class is drawn from the l^{th} leaf may be expressed as:

$${P}_{l , i} = \frac{{ω}_{l , i}}{{N}_{l}} .$$

The vector Pₗ=wₗ/Nₗ may be a probability mass function (PMF). The class H that maximizes the PMF for the i^{th} leaf may be expressed as:

$${H}_{Mode} ( l ) = arg max {p}_{l} .$$

A DTC configured with these assignments is referred to herein as a decision tree classifier mode (DTC-M), for example, because the DTC-M determines the mode of the class random variable described by the PFM. The class H equal to the expectation may be expressed as:

$${H}_{Expectation} ( l ) = ⌊ {{\sum }_{i = 1}}^{{N}_{class}} i \cdot {p}_{l , i} ⌉ ,$$

where |x| is x rounded to the nearest integer. For the DTC-M, the class with the highest count in the leaf node's class distribution is assigned as the class label for that leaf.

The accuracy of DTC predictions increases with the number of features, albeit at the cost of increased complexity. For example, serving cell parameters such as RSSI may be combined with RSTD measurements to improve the accuracy of position estimates based on TDOA techniques. For example, the actual TDOA vector ȟ(x) for PRS transmissions from a pair of base stations may be expressed as:

$${h}^{⋁} ( x ) = h ( x ) + {TDOA}_{error} ,$$

where h(x) is the estimated accuracy vector and TDOAₑᵣᵣₒᵣ is the TDOA residual error. represents the actual TDOA. The TDOA residual error is an important feature that, as described above, may be included in the feature vector used to form the datasets 832 stored in the database 830 of FIG. 8. For hyperbolic TDOA positioning, variance estimation using the Jacobian matrix of the measurement function may be used, for example, where lower variance indicates relatively low TDOA errors (and therefore relatively high positioning accuracy) and higher variance indicates relatively high TDOA errors (and therefore relatively low positioning accuracy).

As described above, the features generated by the UE may include the GDOP, which indicates the geometry of reference points (e.g., base stations) relative to the position estimate. More specifically, the GDOP may be a multiplicative factor that relates TDOA measurement errors to positioning errors. For example, if the RMSE of TDOA measurements is 50 meters and the GDOP=0.5 (which may indicate an acceptable level of geometric alignment of the base stations participating in the positioning operation relative to the UE's location), then the positioning error may be approximately one-half of 50 meters=25 meters. Conversely, the GDOP=4.0 (which may indicate an unacceptable level of geometric alignment of the base stations participating in the positioning operation relative to the UE's location), then the positioning error may be approximately 4*50 meters=200 meters.

In some implementations, the UE may generate new features based on a combination of two or more existing features. For example, in some instances, a new feature may be generated by applying nonlinear transformations to existing features, which may reveal various relationships and patterns in the datasets that were not obtained using the existing features. Aspects of the present disclosure can identify feature transformations that determine additional relationships between the features and the accuracy estimate, and include the transformations that have at least a threshold level of correlation. In some instances, an existing feature and a corresponding transformed feature may be included in the feature vector stored in the database 830 of FIG. 8. For example, rather than using only the distance between the UE's estimated location and the location of the serving cell, the logarithm of the distance may be incorporated into position estimates to account for path loss between the UE and the serving cell. Similarly, the square root of the trace of the covariance matrix associated with the position estimate may have a greater correlation with accuracy than the trace itself, and therefore may also be included in the feature vector stored in the database 830 of FIG. 8.

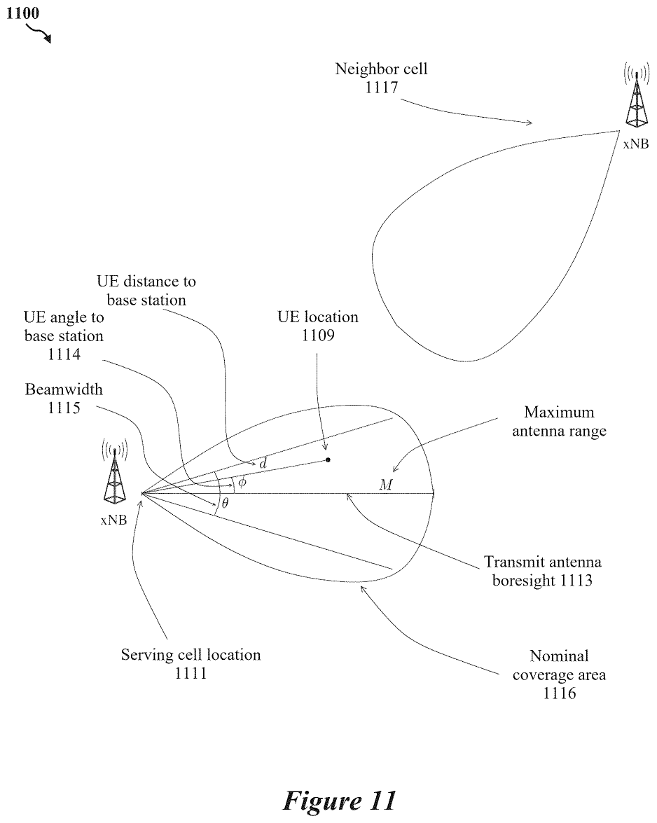

FIG. 11 shows a coverage area 1100 of an example serving cell, in accordance with some implementations. As described below in more detail, various aspects of the present disclosure may utilize a normalized distance-angle product (NDAP) to determine the position of a wireless device such as a UE. As shown, the UE location 1109 is a distance d meters away from the serving cell's location 1111. The serving cell's transmit antenna is a directional antenna with a maximum antenna range (MAR) of M meters, is labeled on the axis the transmit antenna's 1113. For omnidirectional antennas, no such boresight exists as transmit power radiates equally in all directions. Also shown is the angle of the UE's location relative to the boresight axis 1113 and the serving cell's transmit antenna beamwidth 1115. Beamwidth is typically the main lobe's 3-dB width in degrees, indicating the transmit power ranges between maximum and half maximum. The nominal coverage area 1116 of the serving cell depends on the beamwidth and maximum antenna range. In the example of FIG. 10, the UE location 1109 is within the serving cell's nominal coverage area 116 but not within the coverage area of the neighbor cell 1117.

When the UE selects a cell as its serving cell, the UE is likely to be in the nominal coverage area of that cell such that d≤M or d/M≤1 and that |φ|≤θ/2 or 2*|φ|≤1. The normalized distance may be defined as:

$${d}_{N} {=}^{def} \frac{d}{M} .$$

The MAR is a UE-specific similar metric stored in the UE's micro-BSA. The MAR measures the cell size and indicates how far from the serving cell transmission point UEs are likely to reside. Another term for this might be antenna horizontal range (AHR). If not specified in the UE's micro-BSA, the AHR can be computed through field measurements, software network models, or inferred from network design. For example, the MAR might be defined as half the distance to the nearest neighbor cell whose boresight extends into the serving cell's nominal coverage area 1116.

The normalized angle may be defined as:

$${ϕ}_{N} {=}^{def} 2 \frac{\vert ϕ \vert}{θ} .$$

The normalized distance and angle are likely to be less than or equal to 1. Consequently, their product is even more likely to be less than one. This product (G) is defined as the normalized distance-angle product (NDAP):

$$G {=}^{def} {d}_{N} \times {ϕ}_{N} = 2 \frac{d \vert ϕ \vert}{M θ} .$$

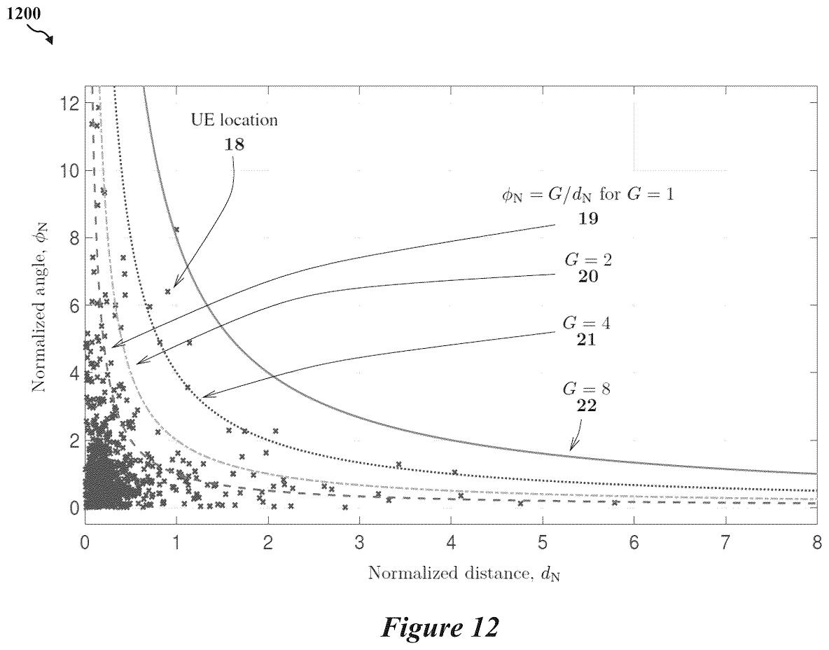

FIG. 12 shows a graph 1200 depicting example relationships between the normalized angle (φN) and the normalized distance (d_{N}) for network data captured in the United States, in accordance with some implementations. More specifically, FIG. 12 includes four curves 19-22 each plotting d_{N} on the x-axis and φN on the y-axis for captured data in four different environmental scenarios (e.g., rural, urban, and suburban and indoor/outdoor locations) on a cellular network in the United States. Each point 18 on the respective curves 19-22 represents a UE location with its associated (dN, φN), and each of the curves 19-22 is of the form:

$${ϕ}_{N} = \frac{G}{{d}_{N}}$$

for different values of G. Each of the curves 19-22 forms an envelope around the observed UE locations indicated by points 18. The curve 19 for G=1 includes the largest number of UE location points 18, followed by the curve 20 for G=2, then by the curve 21 for G=4, and lastly the curve 22 for G=8 (which includes one UE location point 18. As shown, most of the UE locations are beyond the location estimation range of MAR=4, for example, such as when a base station is positioned atop a hill and can provide clear line of sight to a plurality of UEs positioned on a hill or in associated valleys. In these scenarios, the normalized angle remains relatively small (such as less than 1), thereby indicating the UE is closely aligned with the boresight of the serving cell.

For cases where dN>>1, the normalized angle remains less than 1. The normalized angle φN may reach higher values (such as φN=10) when UE is near the base station and within the MAR. In this manner, although a UE may exceed either the normalized distance or the normalized angle, the UE is not likely to exceed both the normalized distance and the normalized angle at the same time.

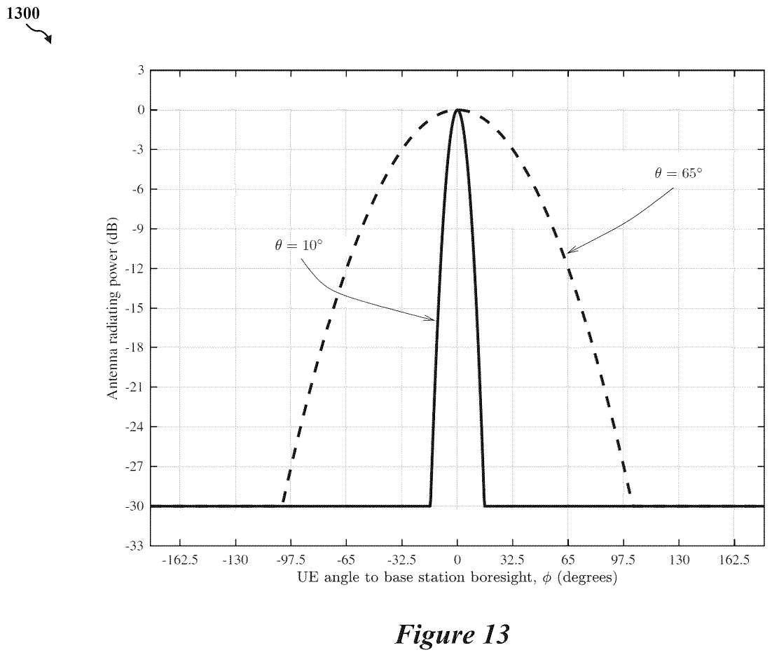

FIG. 13 shows a serving cell nominal coverage area 1300 that may be used to describe when the normalized angle φN of a UE can exceed unity. More specifically, FIG. 13 depicts a 3GPP model of the base station transmit antenna power as:

$$Antenna radiating power ( dB ) = - min \{ 12 ( \frac{ϕ}{θ} ) , 30 \} ,$$

where φ is the angle between the serving cell boresight and the UE and θ is the serving cell's 3 dB beamwidth. The solid line represents a cell with a narrow 10° 3-dB beamwidth, suitable for covering narrow areas such as freeway corridors. The dashed line represents a cell with a broader 65° 3-dB beamwidth. For ØN=3 and θ=65°, the UE angle φ=±φN*φ/2=±φN 3*65/2=±97.5°. At this angle, the base station antenna transmit power is 27 dB lower than its maximum. Despite this, a UE may still select a such a cell as its serving cell, for example, as depicted in FIG. 11.

In practice, a UE very close to a base station can select it as its serving cell even if it is pointing away from the UE. In this case, the UE is seeing the back lobe of the base station transmitting antenna pattern. Suppose this were to happen with θ=65° and φ=180°, then the normalized angle is φN=2*180°/65°=5.5 (which helps to explain the sparsity of UE locations in the upper-left side of FIG. 13. For the narrow beamwidth θ=10° cell in FIG. 13, the normalized angle extends to 36, further illustrating how this value can grow large in practice.

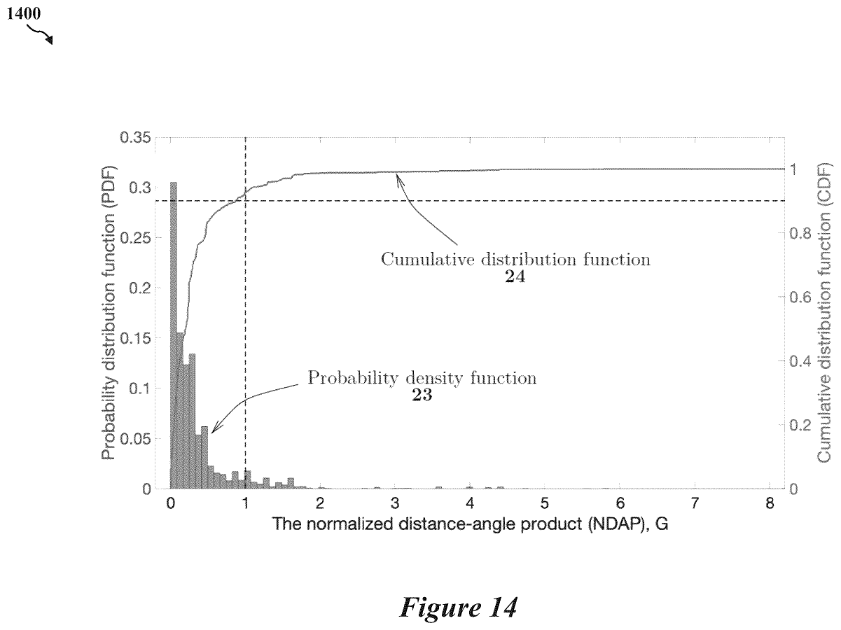

FIG. 14 shows a graph 1400 depicting normalized distance and angle product (NDAP) information associated with the network data, in accordance with some implementations. In contrast to the plot 1200 of FIG. 12 (which depicts that most of the UE locations 18 fall below the G=1 curve and that even more of the UE locations 18 fall below the G=8 curve), the graph 1400 of FIG. 14 plots the probability density function (PDF) 23 on the left-side y-axis as bars and the cumulative distribution function (CDF) 24 on the right-side y-axis as a solid line. More than 90% of the observed G values are less than one, and it is unlikely that the G value will exceed two. This result from real-life field data confirms the intuition that the NDAP is likely one or less.

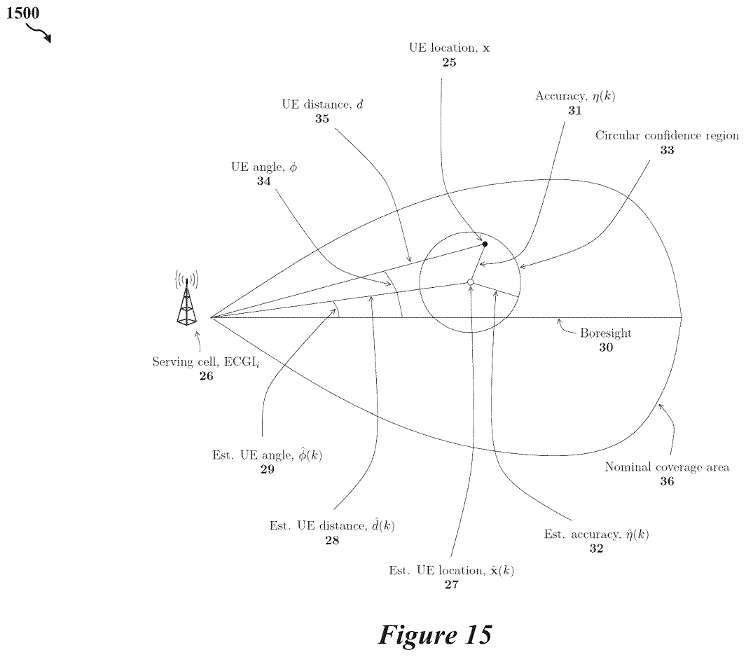

FIG. 15 shows an example plot 1500 depicting an estimated UE location in relation to its true location in its nominal serving cell coverage area, in accordance with some implementations. In various aspects, the plot 1500 depicts the NDAP statistics for an example capture log generated by the UE, for example, as described above with respect to FIG. 6. More specifically, FIG. 15 shows a UE 25 with serving cell ECGIi 26. The serving cell transmission point is at the origin (0,0) of a polar coordinate system, placing the UE at location (d,φ). The estimate is (d′(k),φ′(k)), where d′(k) is the estimated UE distance 28 to the serving cell at time k, and φ′(k) is the estimated UE angle 29 relative to the boresight 30. The true accuracy 31 of the position estimate is n(k), as computed in (1). The estimated accuracy \tilde{η}(k) 32 is computed by an algorithm to form a confidence region 33. In this case, the confidence region encircles the actual UE location, demonstrating the accuracy of the estimation method.

The accuracy estimator determines the probability that the UE is located at the location given by (d(k), (k)). For a given serving cell ECGIi, the NDAP associated with the estimated UE location is:

$$\hat{G} ( k ) = 2 \frac{\hat{d} ( k ) \vert \hat{ϕ} ( k ) \vert}{M θ} .$$

If this parameter is less than one, then the estimated UE location is likely accurate. If this parameter is relatively large, the estimated UE location may not be accurate and may result in a larger (k). Since G(k) is associated with the serving cell ECGIi, the accuracy estimator can determine the probability that the UE is located at (d(k), ¢(k)) given the serving cell ECGIi and use the value of G(k) as a guide.

Bayes' Theorem may be used to determine the probability of “A” given “B” as:

$$P ( A \vert B ) = \frac{P ( B \vert A ) P ( A )}{P ( B )} .$$

Consider the following context:
P(A|B): posterior probability—the probability that hypothesis A (the UE is located at (\hat{d}(k),\hat{φ}(k))) is true given the evidence B (the UE selects ECGIᵢ as the serving cell).
P(B|A): likelihood—the probability of observing evidence B given that hypothesis A is true, indicating how likely the UE would select ECGIᵢ as its saving cell at (\hat{d}(k),\hat{φ}(k))·
P(A): prior probability—the probability of hypothesis A before considering evidence B, reflecting the likelihood that the UE is at (\hat{d}(k),\hat{φ}(k)) irrespective of the serving cell.
P(B): marginal likelihood—the probability of observing evidence B, capturing the general probability that a UE would select ECGI; as its serving cell.
   Historical observations and network design considerations influence these probabilities, crucial for updating beliefs about different hypotheses.

For the observed data from the graph 1500 of FIG. 15, the likelihood P(B[A) is inversely proportion to G:

$$P ( B \vert A ) ∝ \frac{1}{G} .$$

This model suggests that it is improbable for the UE to be significantly distant from its serving cell while the serving cell antenna direction is pointed away from the UE. Other factors influencing the likelihood function P(B[A) are consolidated into a composite parameter W that may be expressed as:

$$P ( B \vert A ) = g ( {d}_{N} , {ϕ}_{N} , Ψ ) ,$$

where g represents an unspecified function. Next, the direct correlation between d_{N} and Φ_{N}, and determine the posterior probability of hypothesis A as:

$$P ( A \vert B ) ∝ g ( {d}_{N} , {ϕ}_{N} , Ψ ) .$$

Therefore, d_{N}, Φ_{N}, and NDAP are features that can provide the classifier with information about the probability of hypothesis A. In accordance with aspects of the present disclosure, the ML models disclosed herein can be used to determine the relationship between these features.

Several different candidates for the features used in the design are analyzed, including both readily available variables and novel interaction variables defined earlier. The feature selection process involves a comprehensive analysis of the correlation between different features (including their nonlinear transformations) and the target variable, identifying the most predictive features. Additionally, an in-house recursive feature elimination (RFE) method is employed, training an initial model using all candidate features. Feature importance is determined based on model parameters and domain knowledge, systematically removing the least important features in each iteration. This iterative refinement continues until it achieves a balance between complexity and performance of the ML model. The final features election ensures the model's complexity remains manageable while maintaining robust predictive performance.

The importance of each feature is calculated as the summation of the importance of the nodes that split on that feature. Feature importance analysis reveals that features calculated based on the estimated position of the UE have the most significant effect on the model. These features include estimated free-range path loss, normalized distance by MAR, distance itself, angle-to-opening ratio, and NDAP. Additionally, GRP, GDOP, and cell density significantly influence the model's decisions, consistently appearing at the top levels of the tree and indicating their crucial role in distinguishing between different classes. The next step, data, preprocessing, involves cleaning the data to handle missing values, addressing inconsistencies, and identifying outliers. Additionally, scaling standardizing, or normalizing numerical values in both the input and output sets is often crucial. However, for decision tree classifiers, these steps may be necessary only in specific cases. During this phase, data points where the positioning algorithm found no location estimate were removed. The calculated cell density is scaled to manage its magnitude, and the lower bound of the serving cell opening angle is adjusted to address outliers in normalized angle values.

Aspects of the present disclosure may apply data augmentation when training the ML model 700 of FIG. 7. For example, an engineer travels to a specific location x and captures data across K time instances, generating K feature vectors and K accuracies, as described above. Staying at this location, the engineer collects M such captures, providing time diversity and different perspectives of the same event. These captures are not fully independent but exhibit variability, enhancing data robustness. Additionally, small movements of the test device between and within captures contribute spatial diversity. For a given location x, this data augmentation increases the dataset size to KM. For instance, with K=32 and M=5, K M=160.

Another form of data augmentation involves variations in the configuration of the position estimation model. Each configuration, known as a device under test (DUT), can significantly affect performance metrics, particularly regarding high position estimation accuracy. Different DUT configurations may involve varying threshold settings, algorithm configurations, and other parameters. While multiple DUT configurations may achieve desirable performance outcomes, they can result in distinct sets of feature vectors from the same K=32 capture occasions.

Suppose there are D such DUTs used in machine learning. This form of data augmentation increases the size of the training set by a factor of KMD. Continuing the example with D=10, this yields KM D=1600. Augmentation in this manner provides more diversity in the data, helping to prevent overfitting the machine learning model to a single DUT configuration. It exposes the model to a broader range of scenarios, enhancing its generalization capability and robustness to different conditions. For a data collection campaign that collects L unique locations {x1}f=1, the amount of data available for training grows to KM DL datasets. In this example with L=1000, this results in KM DL=1.6 million.

In pursuit of augmenting the available dataset, various approaches are explored. Perturbing existing datasets and generating new positioning solutions provide more data for the training process. For instance, introducing additive white Gaussian noise (AWGN) at different power levels to the I/Q samples collected at each unique location, as well as perturbing the known locations of base stations from the assistance data, can be used to simulate different possible channel effects. Essentially, the inputs to the positioning algorithm can be perturbed, and accordingly, the system generates a new set of data points to augment the originally available dataset.

Additionally, the outputs of the system, irrespective of the inputs and algorithmic model of the positioning system, can also be perturbed through advanced data-driven methods such as Gaussian Processes (GPs). GPs are powerful tools for probabilistic modeling that can estimate the distribution of feature sets for each class in the classifier. GPs enable the generation of additional data points that adhere to the same underlying distribution associated with each corresponding class, thereby potentially increasing the size and diversity of the training dataset. This method theoretically allows for an unlimited number of new data points. However, the challenge with GPs is that the assumption that new samples drawn from the estimated distribution will have the same label as the original class might not always hold, potentially introducing noise and reducing the classifier's accuracy. The more comprehensive the original dataset distribution is, the more beneficial methods such as GPs will be.

Referring also to FIG. 10, the classifier 1010 may be trained with labeled data to identify patterns and relationships between features and target labels. The augmented dataset is divided into training and testing sets, typically with 80% used for training and 20% for testing. The decision tree algorithm partitions the feature space based on feature values to optimize the homogeneity of the target variable within each partition. This process continues until certain stopping criteria are met, such as a minimum number of samples in a leaf node or a maximum tree depth. These criteria help prevent overfitting and improve the model's generalization ability to new data.

In some aspects, training the DTC disclosed herein involves fine-tuning hyperparameters to strike a balance between complexity and performance. In refining hyperparameters, factors such as maximum tree depth, maximum leaf nodes and data splitting criteria are considered. A systematic approach like grid search is employed to determine the most effective combination of hyper parameters. Grid search involves specifying a grid of hyperparameter values and systematically exploring this grid to evaluate the classifier's performance using k-fold cross-validation. Cross-validation ensures the classifier classifies data instances adeptly while mitigating overfitting risks and achieving robust generalization to new datasets. The hyperparameter configuration that yields the highest model accuracy, as the target performance metric, is identified as the optimal combination for the final model. For an N_{dataset} Vector of true class IDs H and estimated class IDs H, the model accuracy is calculated as:

$$Model accuracy = \frac{1}{{N}_{dataset}} {\sum }_{i = 1}^{{N}_{dataset}} \text{?} ( {H}_{i} = {\hat{H}}_{i} ) ,$$

where Hᵢ is the ith element of H, Ĥᵢ is the ith element of Ĥ, and [symbol] (x) is the Heaviside step function returning one when the argument x is true and zero otherwise.

Another aspect identified during the hyperparameter search is the splitting criterion, a cornerstone in partitioning feature space by decision trees. The cross-entropy loss function criterion is chosen, leveraging the Shannon information gain to evaluate potential splits. The primary objective of the splitting criterion is to maximize information gain at each split, facilitating the segregation of data points into homogeneous groups while minimizing impurity. This logarithmic loss criterion offers a robust measure of uncertainty reduction, leading to more effective decision boundaries and improved model performance. For further insights into the log-loss criterion.

Through hyperparameter search, the maximum tree depth is established as the stopping criterion for the decision tree model. During training, the decision tree grows deeper until it reaches this maximum depth or another stopping criterion, whichever occurs first. Limiting the tree depth controls the model's complexity, preventing overfitting by avoiding memorizing noise in the training data. For a tiny ML design suitable for low-power consumption systems, minimizing computational cost is crucial, as it increases with tree depth. Thus, a shallower tree is more desirable to reduce computational cost and avoid overfitting.

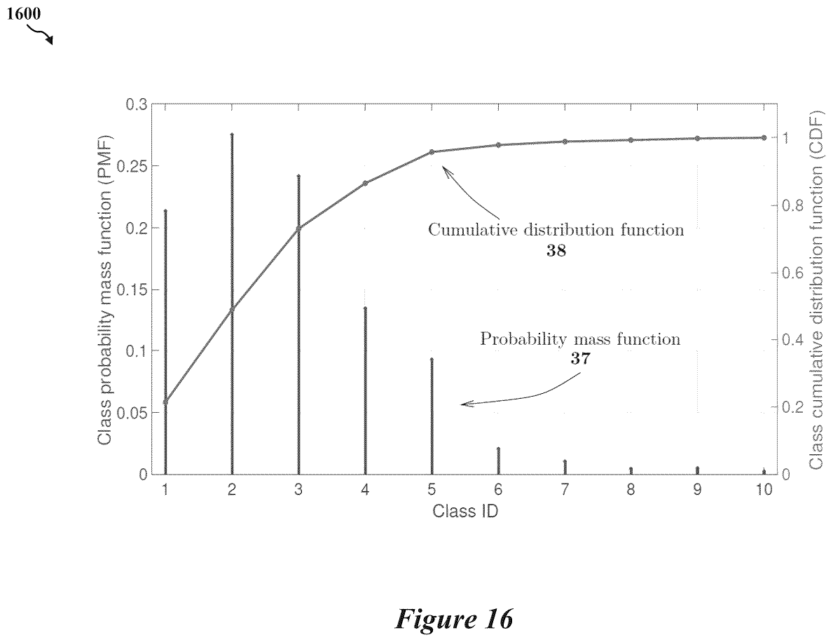

FIG. 16 shows a graph 1600 depicting the class probability mass function (PMF) and the class cumulative distribution function (CDF) as a function of class ID, in accordance with some implementations. More specifically, the graph 1600 depicts the class distribution of the available dataset. Around 96% of the data have a class ID of up to five, indicating less than 640 m of error. This can introduce model biases toward lower errors. This imbalance can be addressed by selecting more lower-frequency events for training or by defining class weights to give more weight to the lower-frequency events.

In the model development process, class imbalance within the dataset is addressed using class weight balancing. This issue arises when certain classes are significantly underrepresented, potentially biasing model predictions. Instead of equalizing the number of samples from each class, potentially leading to information loss and reduced model performance, class weight balancing adjusts the weights assigned to each class during training. It assigns higher weights to instances of minority classes and lower weights to instances of majority classes based on their frequencies in the input data. This approach ensures effective learning from all available data while placing more emphasis on the less-represented classes.

After training the ML model 600, it is crucial to evaluate its performance and analyze its strengths, weaknesses, and real-world applicability. The evaluation process includes assessing the effectiveness of the model using a diverse range of metrics, providing valuable insights into various aspects of the model's performance, including its ability to classify instances accurately, detect outliers, and establish system reliability—an essential factor for systems deployed to end-users.

A useful metric is the Pearson correlation coefficient:

$$ρ = \frac{{\sum }_{i = 1}^{{N}_{dataset}} ( {η}_{i} - \overline{η} ) ( {η}_{i} - \overline{\hat{η}} )}{\sqrt{{\sum }_{i = 1}^{{N}_{dataset}} {( {η}_{i} - {η}^{…} )}^{2} {\sum }_{i = 1}^{{N}_{dataset}} {( {\hat{η}}_{i} - {\hat{η}}^{…} )}^{2}}} ,$$

where the bar over the vector represents the vector average. The coefficient p has a value that can range from −1 to +1, where +1 indicates a perfect positive linear relationship, −1 indicates a perfect negative relationship, and zero indicates no relationship. Another useful metric is containment:

$$γ = \frac{1}{{N}_{dataset}} {\sum }_{i = 1}^{{N}_{dataset}} \text{?} ( {\hat{η}}_{i} \geq {η}_{i} ) .$$

When the estimated accuracy exceeds the true accuracy, the confidence region includes the actual device location x. The goal is to maximize γ towards without being excessively pessimistic. While γ=1 is achievable for \tilde{η}=∞, such an estimator is meaningless. The correlation-containment product is α=γ, where a value of α closer to +1 indicates better performance. This combined measure effectively discounts the \tilde{η}=∞ estimator, ensuring meaningful evaluations.

For this application, a useful metric measures the success rate of the model:

$$β = \frac{1}{{N}_{dataset}} {\sum }_{i = 1}^{{N}_{dataset}} \text{?} ( \frac{{\tilde{η}}_{i}}{2} \leq {\hat{η}}_{i} \leq 2 {\tilde{η}}_{i} ) .$$

Success is declared when the estimated accuracy falls within the range of the true class H, or the adjacent classes H−1 or H+1.

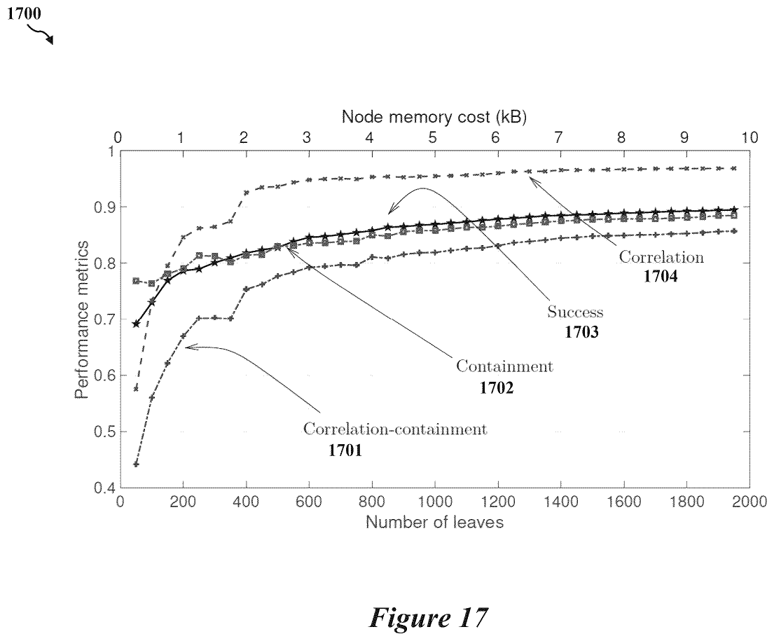

FIG. 17 shows a graph 1700 depicting first performance metrics of a positioning operation as a function of the complexity of a mode-based decision tree classifier (DTC-M) used in the positioning operation, in accordance with some implementations. More specifically, the complexity of the DTC is represented along the lower x-axis as the number of leaves in the DTC, and is represented along the upper x-axis as the amount of memory associated with implementing the DTC. The performance metrics are indicated on the y-axis of the graph 1700, where a performance metric of zero indicates unsatisfactory performance and a performance metric of one indicates excellent performance. As shown in FIG. 17, the graph 1700 includes a first plot 1701 representing the correlation-containment, a second plot 1702 representing the containment, a third plot 1703 representing the success, and a fourth plot 1704 representing the correlation. The metrics exhibit the desired property of increasing monotonically with complexity. For a cost of 2 kB, a 400-leaf DTC-M achieves 92% correlation 41, 81% containment 40, and 82% success 42, for a dataset containing both the training and testing sample sets.

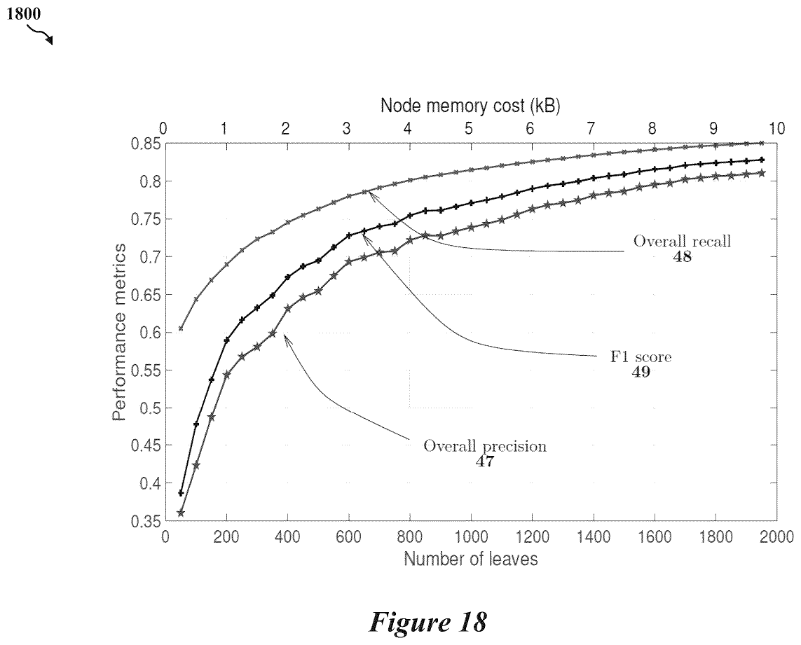

FIG. 18 shows a graph 1800 depicting second performance metrics of a positioning operation as a function of the number of leaves of the DTC-M used in the positioning operation, in accordance with some implementations. More specifically, the recall of the i^{th} class may be expressed as:

$${Recall}_{i} = \frac{CM ( i , i )}{{\sum }_{j = 1}^{{N}_{class}} CM ( i , j )} ,$$

where CM(i,j) is the i^{th} row and j^{th} column of the raw confusion matrix. The overall macro recall is:

$$Overall recall = \frac{1}{{N}_{class}} {\sum }_{i = 1}^{{N}_{class}} {Recall}_{i} .$$

Similarly, the precision of the i^{th} class is:

$${Precision}_{i} = \frac{CM ( i , i )}{{\sum }_{j = 1}^{{N}_{class}} CM ( i , j )} .$$

and the overall macro precision may be expressed as:

$$Overall precision = \frac{1}{{N}_{class}} {\sum }_{i = 1}^{{N}_{class}} {Precision}_{i} .$$

Note that the graph 1800 of FIG. 18 also plots the F1 score as:

$$F 1 score = 2 \times ( \frac{Overall precision \times Overall recall}{Overall precision + Overall recall} ) .$$

This result shows that each measure increases with complexity. The 400-leaf DTC-M has an overall precision of 64%, an overall recall of 75%, and an F1 score of 0.68.

Another useful family of metrics for evaluating the model is the root mean squared error (RMSE), an overall value for which may be expressed as:

$${RMSE}_{overall} = \sqrt{\frac{1}{{N}_{dataset}} {\sum }_{i = 1}^{{N}_{dataset}} {( {\hat{η}}_{i} - {η}_{i} )}^{2}} .$$

This is considered the overall RMSE since it measures the difference between the ground truth values and the estimated values. An RMSE between the ground truth labels and the estimates is the label RMSE, which may be expressed as:

$${RMSE}_{label} = \sqrt{\frac{1}{{N}_{dataset}} {\sum }_{i = 1}^{{N}_{dataset}} {( {\hat{η}}_{i} - {\overline{η}}_{i} )}^{2}} .$$

RMSE_{label} is nearly the same as RMSEₒᵥₑᵣₐₗₗ, but it replaces η with \tilde{η} to account for the class mapping, for example, as shown in Table 1. The class RMSE compares the ground truth classes H with the corresponding estimates H.

And finally, the mapping RMSE compares the ground truth to the class labels as expressed below:

$${RMSE}_{mapping} = \sqrt{\frac{1}{{N}_{dataset}} {\sum }_{i = 1}^{{N}_{dataset}} {( {\tilde{η}}_{i} - {η}_{i} )}^{2}} .$$

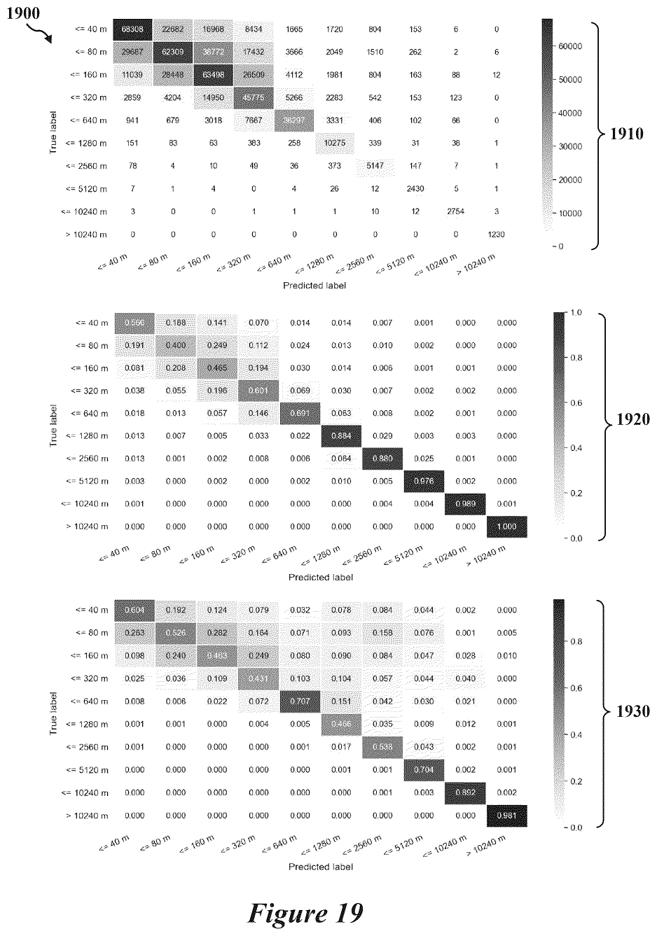

FIG. 19 shows example DTC-M matrices 1900, in accordance with some implementations. The matrices 1900 include a raw confusion matrix 1910, a recall confusion matrix 1920, and a precision confusion matrix 1930 for a 400-leaf DTC-M. The raw confusion matrix 2010 shows the distribution of classifications for a given dataset. The matrix diagonal signifies perfect classifications, where Ĥ=H for a given sample. Off-diagonals represent misclassifications. For example, 16,968 Class 1 samples (H=1) are misclassified as Class 3 (H=3). In this case, the classifier is overly pessimistic, but containment γ is achieved. Conversely, 11,039 Class 3 samples (H=3) are optimistically classified as Class 1 (H=1), where containment fails. In these cases, the confidence circle 33 of FIG. 15 does not contain the UE's actual location x. Pessimistic misclassifications are preferred over-optimistic ones since they achieve containment. The design shows this tendency since the upper triangle is more populated than the lower triangle of the raw confusion matrix 1910.

The recall confusion matrix 1920 is similar to the raw confusion matrix 1910, except that recall confusion matrix 1920 normalizes values across rows. For a given class H, the rate that the classifier recalls Ĥ=H equals the H^{th} diagonal element. The probability of perfect recall is represented by that value. The H^{th} row and (H+1)^{st} column is the rate that the classifier incorrectly chooses Ĥ=H+I, and so on. In some aspects, the recall confusion matrix 1920 may be linked to the success rate. For example, 46.5% of Class 3 samples (H=3) are perfectly classified (H=3), 20.8% are misclassified one class lower (H=2), and 19.4% are misclassified one class higher (H=4). The success rate is therefore (46.5+20.8+19.4) %=86.7% for Class 3 samples in the example dataset. The ML-CR invention is optimized to detect high error anomalies, as is demonstrated in the figure. For example, high-error Class 9 events are relatively rare, and the success rate is nearly perfect: (98.9+0.4+0.1) %=99.4%.

The precision confusion matrix 1930 is similar to the recall confusion matrix 1920 except that the precision confusion matrix 1930 normalizes the raw matrix down columns. The precision rate of an estimate is the H^{th} diagonal element. Consider the Class-2 estimate (H=2). Its precision rate is 52.6%; 19.2% belong to Class 1, and 24% to Class 3. So, (52.6+19.2+24)%=95.8% of these estimates are within one precision class. None belong to high-error Class 9 or 10, and less than 1% belong to Class 5 to Class 8.

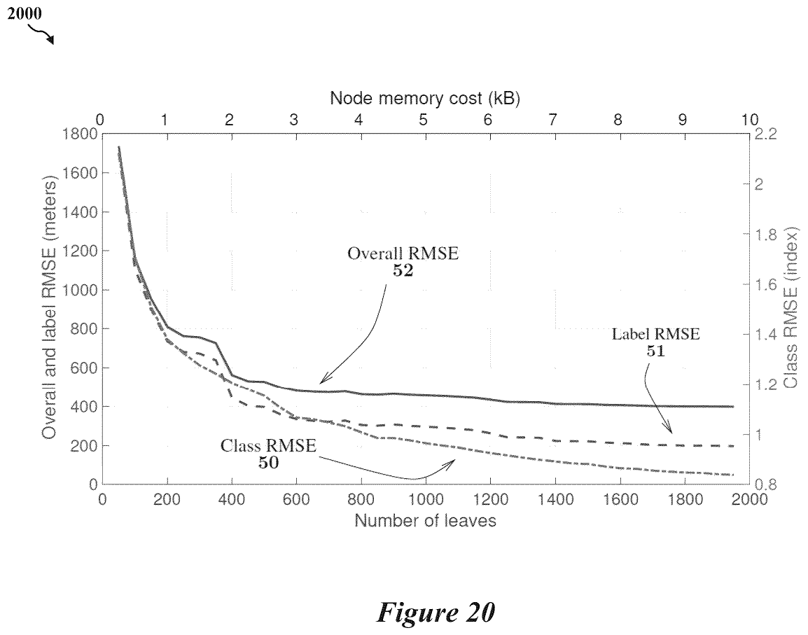

FIG. 20 shows a graph 2000 depicting the label RMSE values of a DTC-M as a function of the number of leaves of the DTC-M, in accordance with some implementations. More specifically, the graph 2000 depicts the RMSE results relative to the complexity of the DTC-M. Notably, error metrics decrease consistently with increased complexity. Note that diminishing returns becoming evident around 500 leaves (2.5 KB), where the label RMSE 51 reaches 400 m. To halve this error to 200 m, an increase to 1,800 leaves (9 kB) is necessary (a 3.6-fold complexity increase). At 500 leaves, the class RMSE 50 stands at approximately 1.1 indices, while the overall RMSE 52 is about 550 m.

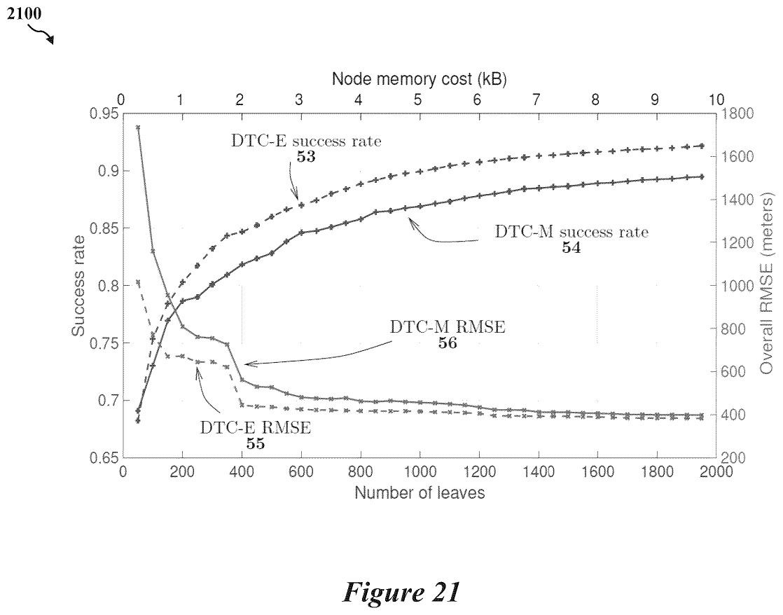

FIG. 21 shows a plot 2100 depicting the relative performances of the DTC-M and an expectation-type decision tree classifier (DTC-E), in accordance with some implementations. More specifically, the plot 2100 compares performance for the DTC-M (11) and the DTC-E (12), where the DTC-E demonstrates better performance. Suppose an 82% success rate for a 400-leaf DTC-M is considered adequate. Achieving this level of performance with a 250-leaf DTC-E represents a complexity reduction of (250−400)/400=37.5%.

The model training process is iterated using evaluation metrics to refine performance. Once the model achieves the desired accuracy, features, thresholds, class labels, and weights assigned to leaf nodes can be extracted into a text file using a suitable toolkit. A toolset has been developed to convert this text file into a format compatible with various software and firmware environments. Specifically, the tools generate a C++ subroutine from the DTC-output text file, facilitating integration into UE firmware development. This subroutine can be deployed to the UE via FOTA technology. The efficient memory usage of the model enables seamless integration and deployment.

At each positioning occasion, the UE computes the feature vector from the parameters and outputs of the positioning algorithm at the time and determines a confidence region for the estimated position. This estimated confidence region can be communicated to the user and is used in other algorithm modules. For instance, it may halt the positioning algorithm from seeking a new estimate once the desired accuracy is attained. Alternatively, it could restart the algorithm with a different setting or trigger backup algorithms if the desired accuracy is not achieved within the specified number of positioning algorithm iterations.

The model will continuously undergo retraining with new data to adapt to evolving conditions, ensuring continual accuracy and reliability. Over time, the training dataset will expand through further testing, allowing for the generation of improved models that leverage newly available data. As previously discussed, various methods were incorporated to augment the field dataset. However, spatial diversity in the available data remained challenging for augmentation efforts. Increasing field data capture is the primary means to introduce spatial diversity, enabling the development of models with enhanced performance. New models can be downloaded by the UE via FOTA. Furthermore, advancements in the core positioning algorithm may prompt a redesign and retraining of the ML-CR model to better match features and thresholds for the newly designed device.

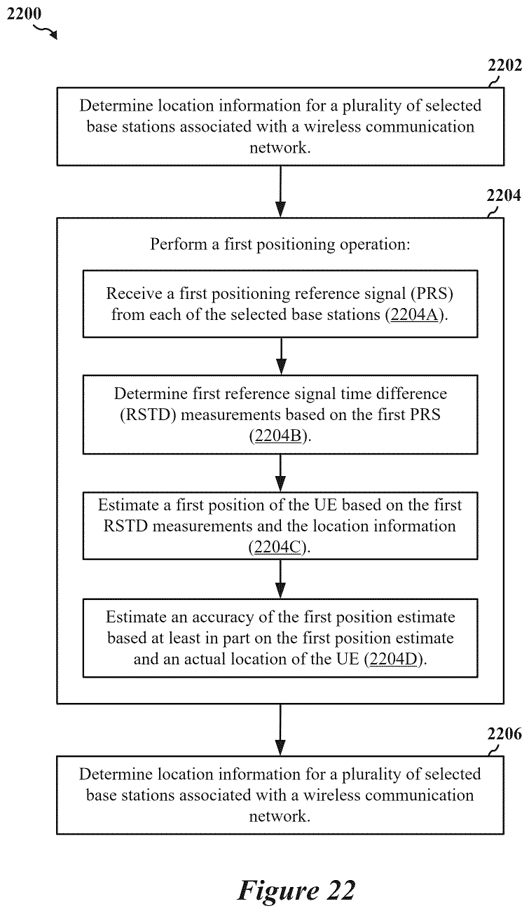

FIG. 22 shows a flow chart depicting an example operation 2200 for estimating positing accuracy of a UE, in accordance with some implementations. In some implementations, the operation 2200 may be performed by the UE 350 of FIG. 3. At 2202, the UE determines location information for a plurality of selected base stations associated with a wireless communication network. At 2204, the UE performs a first positioning operation by receiving, over the wireless communication network, a first positioning reference signal (PRS) from each of the selected base stations (2204A), determining first reference signal time difference (RSTD) measurements based on the first PRS (2204B), estimating a first position of the UE based on the first RSTD measurements and the location information (2204C), and estimating an accuracy of the first position estimate based at least in part on the first position estimate and an actual location of the UE (2204D). Then, at 2206, the UE performs a second positioning operation based at least in part on the accuracy estimate determined for the first positioning operation. In some instances, determining the location information includes retrieving, from a memory associated with the UE, location data for the plurality of selected base stations. In some aspects, the location data stored in the UE is a subset of a base station almanac (BSA) associated with the wireless communication network.

In some implementations, performing the second positioning operation includes receiving, over the wireless communication network, a second PRS from each of the selected base stations, determining second RSTD measurements based on the second PRS and the accuracy estimate of the first position estimate, and estimating a second position of the UE based on the second RSTD measurements, the location information, and the accuracy estimate of the first position estimate. In some instances, performing the second positioning operation further includes estimating an accuracy of the second position estimate based at least in part on the second position estimate and the actual location of the UE.

In various aspects, estimating the second position of the UE may include dynamically adjusting one or both of the second RSTD measurements and the second estimated position based on the accuracy estimate for the first positioning operation. In addition, or in the alternative, the second positioning operation further includes estimating an accuracy of the second position estimate based at least in part on the second position estimate and the actual location of the UE.

In some implementations, the accuracy estimate is generated by a decision tree classifier based at least in part on a feature vector generated by the UE during the first positioning operation. The feature vector may include a number of base stations participating in the first positioning operation, a time-difference of arrival (TDOA) residual error, an estimated geometric dilution of precision (GDOP) of the accuracy estimate, and a normalized distance and angle product (NDAP) of the first position estimate generated by the UE during the first positioning operation. In some instances, the accuracy estimate generated by the decision tree classifier is further based on one or more operating parameters of at least one of the base stations. The one or more operating parameters includes a nominal ranging distance of the at least one base station, a maximum antenna range (MAR) of the at least one base station, a received signal strength indicators (RSSI) of the at least one base station, and an effective isotropically radiated power (EIRP) of the at least one base station.

The decision tree classifier may be trained by a management server associated with the wireless communication network using datasets generated by the UE during a plurality of previous positioning operations. In some aspects, the trained decision tree classifier may be obtained by the UE from the management server as an over-the-air firmware update.

In some implementations, the method may also include capturing in-phase (I) and quadrature (Q) components of PRS received during a plurality of previous positioning operations, determining a device state vector indicating one or more of a received signal strength indicator (RSSI), a reference signal received power (RSRP), a reference signal received quality (RSRQ), PRS timestamps, angle of departure (AoD) information, angle of arrival (AoA) information, or band information for each of the plurality of previous positioning operations, generating a capture log by concatenating the captured I/Q components and the device state vector, and forming the datasets based on a combination of the capture log and the feature vector. In some aspects, the method may also include training the decision tree classifier using the datasets.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. Unless otherwise specified in this disclosure, for construing the scope of the term “about” or “approximately,” the error bounds associated with the values (dimensions, operating conditions etc.) disclosed is ±10% of the values indicated in this disclosure. The error bounds associated with the values disclosed as percentages is ±1% of the percentages indicated. The word “substantially” used before a specific word includes the meanings “considerable in extent to that which is specified,” and “largely but not wholly that which is specified.”

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations can also be implemented in combination in a single implementation. Conversely, various features that are described in the context of a single implementation can also be implemented in multiple implementations separately or in any suitable subcombination. As such, although features may be described above in combination with one another, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example operations in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

What is claimed is:

1. A method for estimating positioning accuracy for a user equipment (UE), the method performed by the UE and including:
determining location information for a group of base stations associated with a wireless communication network;
performing a first positioning operation by:
receiving, over the wireless communication network, a first positioning reference signal (PRS) from each of the base stations;
determining first reference signal time difference (RSTD) measurements based on the first PRS;
estimating a first position of the UE based on the first RSTD measurements and the location information; and
estimating an accuracy of the first position estimate based at least in part on the first position estimate and an actual location of the UE; and
performing a second positioning operation based at least in part on the accuracy estimate determined for the first positioning operation.

2. The method of claim 1, wherein determining the location information includes retrieving, from a memory associated with the UE, location data for the plurality of selected base stations.

3. The method of claim 2, wherein the location data stored in the UE is a subset of a base station almanac (BSA) associated with the wireless communication network.

4. The method of claim 1, wherein performing the second positioning operation includes:
receiving, over the wireless communication network, a second PRS from each of the base stations;
determining second RSTD measurements based on the second PRS and the accuracy estimate of the first position estimate; and
estimating a second position of the UE based on the second RSTD measurements, the location information, and the accuracy estimate of the first position estimate.

5. The method of claim 4, wherein the second positioning operation further includes:
estimating an accuracy of the second position estimate based at least in part on the second position estimate and the actual location of the UE.

6. The method of claim 4, wherein estimating the second position includes dynamically adjusting one or both of the second RSTD measurements and the second estimated position based on the accuracy estimate for the first positioning operation.

7. The method of claim 1, wherein the accuracy estimate is generated by a decision tree classifier based at least in part on a feature vector generated by the UE during the first positioning operation.

8. The method of claim 7, wherein the feature vector includes a number of base stations participating in the first positioning operation, a time-difference of arrival (TDOA) residual error, an estimated geometric dilution of precision (GDOP) of the accuracy estimate, and a normalized distance and angle product (NDAP) of the first position estimate generated by the UE during the first positioning operation.

9. The method of claim 8, wherein the accuracy estimate generated by the decision tree classifier is further based on one or more operating parameters of at least one of the base stations.

10. The method of claim 9, wherein the one or more operating parameters includes a nominal ranging distance of the at least one base station, a maximum antenna range (MAR) of the at least one base station, a received signal strength indicators (RSSI) of the at least one base station, and an effective isotropically radiated power (EIRP) of the at least one base station.

11. The method of claim 7, wherein the decision tree classifier is trained by a management server associated with the wireless communication network using datasets generated by the UE during a plurality of previous positioning operations.

12. The method of claim 11, wherein the trained decision tree classifier is obtained by the UE from the management server as an over-the-air firmware update.

13. The method of claim 7, further including:
capturing in-phase (I) and quadrature (Q) components of PRS received during a plurality of previous positioning operations;
determining a device state vector indicating one or more of a received signal strength indicator (RSSI), a reference signal received power (RSRP), a reference signal received quality (RSRQ), PRS timestamps, angle of departure (AoD) information, angle of arrival (AoA) information, or band information for each of the plurality of previous positioning operations;
generating a capture log by concatenating the captured I/Q components and the device state vector; and
forming the datasets based on a combination of the capture log and the feature vector.

14. The method of claim 13, further including:
training the decision tree classifier using the datasets.

15. A user equipment (UE) comprising:
a transceiver;
a processor coupled to the transceiver; and
a memory storing instructions that, when executed by the processor, causes the wireless communication device to:
determine location information for a group of base stations associated with a wireless communication network;
perform a first positioning operation by:
receiving, over the wireless communication network, a first positioning reference signal (PRS) from each of the base stations;
determining first reference signal time difference (RSTD) measurements based on the first PRS;
estimating a first position of the UE based on the first RSTD measurements and the location information; and
estimating an accuracy of the first position estimate based at least in part on the first position estimate and an actual location of the UE; and
perform a second positioning operation based at least in part on the accuracy estimate determined for the first positioning operation.

16. The UE of claim 15, wherein execution of the instructions to determine the location information causes the UE to retrieve, from a memory associated with the UE, location data for the plurality of selected base stations.

17. The UE of claim 15, wherein the location data stored in the UE is a subset of a base station almanac (BSA) associated with the wireless communication network.

18. The UE of claim 15, wherein execution of the instructions to perform the second positioning operation causes the UE to:
receive, over the wireless communication network, a second PRS from each of the base stations;
determine second RSTD measurements based on the second PRS and the accuracy estimate of the first position estimate; and
estimate a second position of the UE based on the second RSTD measurements, the location information, and the accuracy estimate of the first position estimate.

19. The UE of claim 18, wherein execution of the instructions to perform the second positioning operation further causes the UE to:
estimate an accuracy of the second position estimate based at least in part on the second position estimate and the actual location of the UE.

20. The UE of claim 18, wherein execution of the instructions to estimate the second position causes the UE to dynamically adjust one or both of the second RSTD measurements and the second estimated position based on the accuracy estimate for the first positioning operation.

21. The UE of claim 15, further including a decision tree classifier configured to generate the accuracy estimate based at least in part on a feature vector generated by the UE during the first positioning operation.

22. The UE of claim 21, wherein the feature vector includes a number of base stations participating in the first positioning operation, a time-difference of arrival (TDOA) residual error, an estimated geometric dilution of precision (GDOP) of the accuracy estimate, and a normalized distance and angle product (NDAP) of the first position estimate generated by the UE during the first positioning operation.

23. The UE of claim 22, wherein the accuracy estimate generated by the decision tree classifier is further based on one or more operating parameters of at least one of the base stations.

24. The UE of claim 23, wherein the one or more operating parameters includes a nominal ranging distance of the at least one base station, a maximum antenna range (MAR) of the at least one base station, a received signal strength indicators (RSSI) of the at least one base station, and an effective isotropically radiated power (EIRP) of the at least one base station.

25. The UE of claim 21, wherein the decision tree classifier is trained using datasets generated by the UE during a plurality of previous positioning operations.

26. The UE of claim 25, wherein the trained decision tree classifier is obtained by the UE from the management server as an over-the-air firmware update.

27. The UE of claim 21, wherein execution of the instructions further causes the UE to:
capture in-phase (I) and quadrature (Q) components of PRS received during a plurality of previous positioning operations;
determine a device state vector indicating one or more of a received signal strength indicator (RSSI), a reference signal received power (RSRP), a reference signal received quality (RSRQ), PRS timestamps, angle of departure (AoD) information, angle of arrival (AoA) information, or band information for each of the plurality of previous positioning operations;
generate a capture log by concatenating the captured I/Q components and the device state vector; and
form the datasets based on a combination of the capture log and the feature vector.

28. The UE of claim 27, wherein execution of the instructions further causes the UE to:
train the decision tree classifier using the datasets.
